(19) United States
(12) Patent Application Publication
(10) Pub. No.: US 2026/0255210 A1
(43) Pub. Date: Aug. 27, 2026

(54) ENERGY POLICY REINFORCEMENT DURING ENERGY CONSERVATION TASKS

(71) Applicant: Samsung Electronics Co., Ltd., Suwon-si (KR)

(72) Inventor: Prakash Reddy Kolan, Plano, TX (US)

(21) Appl. No.: 19/535,876

(22) Filed: Feb. 10, 2026

Related U.S. Application Data
(60) Provisional application No. 63/762,906, filed on Feb. 25, 2025.
(60) Provisional application No. 63/906,093, filed on Oct. 27, 2025.

(51) Int. Cl. H04W 28/02; H04L 47/2475

(52) U.S. Cl. CPC H04W 28/0221; H04L 47/2475

(57) ABSTRACT

Methods and apparatuses for energy policy reinforcement during energy conservation tasks. A method for managing service quality of one or more applications includes receiving application energy tolerance information for an application and receiving energy consumption information associated with the application. The application energy tolerance information includes at least one tolerance value indicating an amount of service quality degradation permitted for the application under one or more energy constraints and at least one service quality level at which the tolerance value is to be applied. The method further includes determining that at least one of the one or more energy constraints is satisfied based on the energy consumption information and the application energy tolerance information, determining, based on the application energy tolerance information, degraded quality of service (QoS) configurations for the application at the at least one service quality level, and enforcing the degraded QoS configurations for the application.

### CROSS-REFERENCE TO RELATED APPLICATIONS AND CLAIM OF PRIORITY

This application claims priority under 35 U.S.C. § 119(e) to U.S. Provisional Patent Application No. 63/762,906 filed on Feb. 25, 2025, and U.S. Provisional Patent Application No. 63/906,093 filed on Oct. 27, 2025. The above-identified provisional patent applications are hereby incorporated by reference in their entirety.

### TECHNICAL FIELD

This disclosure relates generally to wireless networks. More specifically, this disclosure relates to energy policy reinforcement during energy conservation tasks in wireless communication networks including fifth generation (5G) networks.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for energy policy reinforcement during energy conservation tasks.

In one embodiment, a method for managing service quality of one or more applications is provided. The method includes receiving application energy tolerance information for an application and receiving energy consumption information associated with the application from a user equipment (UE) or a network function. The application energy tolerance information includes at least one tolerance value indicating an amount of service quality degradation permitted for the application under one or more energy constraints and at least one service quality level at which the tolerance value is to be applied. The method further includes determining that at least one of the one or more energy constraints is satisfied based on the energy consumption information and the application energy tolerance information, determining, based on the application energy tolerance information, degraded quality of service (QoS) configurations for the application at the at least one service quality level, and enforcing the degraded QoS configurations for the application.

In another embodiment, an electronic device for managing service quality of one or more applications is provided. The electronic device includes memory storing program code and a processor operably coupled to the memory. The processor is configured to execute the program code to cause the electronic device to receive application energy tolerance information for an application and receive energy consumption information associated with the application from a UE or a network function. The application energy tolerance information includes at least one tolerance value indicating an amount of service quality degradation permitted for the application under one or more energy constraints and at least one service quality level at which the tolerance value is to be applied. The processor is configured to execute the program code to cause the electronic device to determine that at least one of the one or more energy constraints is satisfied based on the energy consumption information and the application energy tolerance information, determine, based on the application energy tolerance information, degraded QoS configurations for the application at the at least one service quality level, and enforce the degraded QoS configurations for the application.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example 5GMS architecture according to embodiments of the present disclosure;

FIG. 5 illustrates an example energy policy enforcement according to embodiments of the present disclosure;

FIG. 6 illustrates an example energy policy enforcement function in an operator network according to embodiments of the present disclosure;

FIG. 7 illustrates an example energy policy enforcement function with expiry information according to embodiments of the present disclosure;

FIG. 8 illustrates an example energy policy enforcement function for multiple time periods according to embodiments of the present disclosure;

FIG. 9 illustrates an example configuration of application tolerance for reduced service quality due to energy constraints according to embodiments of the present disclosure;

FIG. 10 illustrates an example procedure for degradation of application quality of service (QoS) due to energy constraints according to embodiments of the present disclosure;

FIG. 11 illustrates an example configuration of group tolerance for reduced service quality due to energy constraints according to embodiments of the present disclosure;

FIG. 12 illustrates an example procedure for QoS degradation of applications in groups due to energy constraints on one or more individual applications according to embodiments of the present disclosure;

FIG. 13 illustrates an example method for determining how the QoS of each application is to be adjusted according to embodiments of the present disclosure;

FIG. 14 illustrates an example configuration of unified energy group QoS according to embodiments of the present disclosure;

FIG. 15 illustrates an example procedure for QoS degradation of applications in an application group based on unified group QoS tolerance according to embodiments of the present disclosure;

FIG. 16 illustrates an example procedure for QoS degradation of applications given reduced QoS configuration for application energy tolerance according to embodiments of the present disclosure;

FIG. 17 illustrates an example procedure for QoS degradation of applications given QoS configurations for regular and energy constrained scenarios according to embodiments of the present disclosure; and

FIG. 18 illustrates an example method for energy policy reinforcement during energy conservation tasks according to embodiments of the present disclosure.

### DETAILED DESCRIPTION

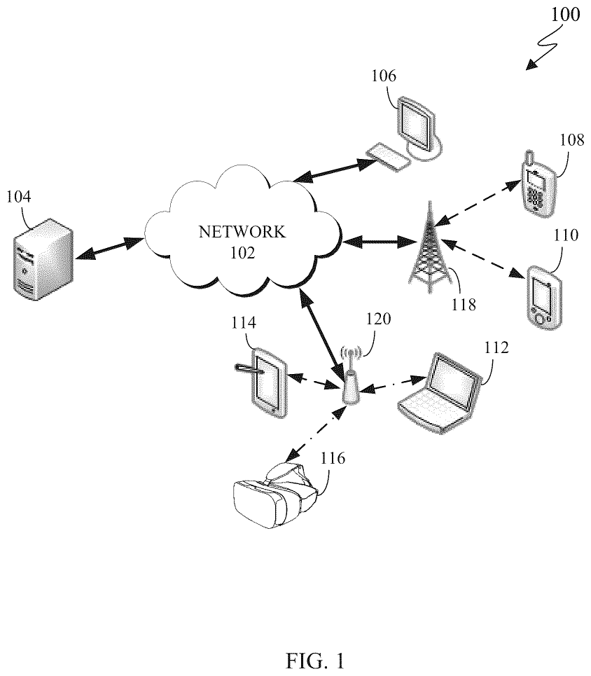

FIGS. 1 through 18, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

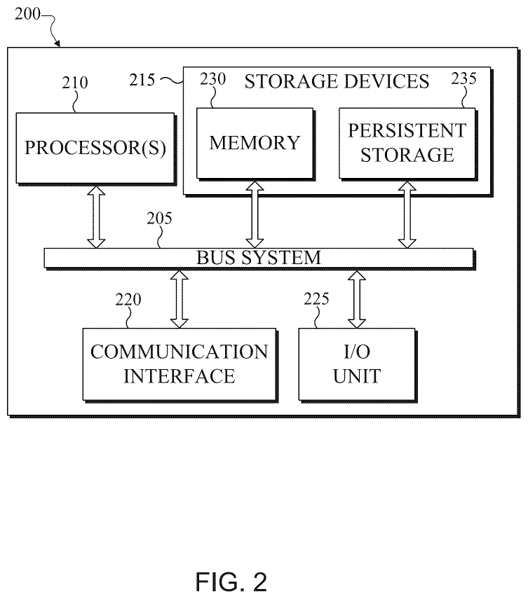

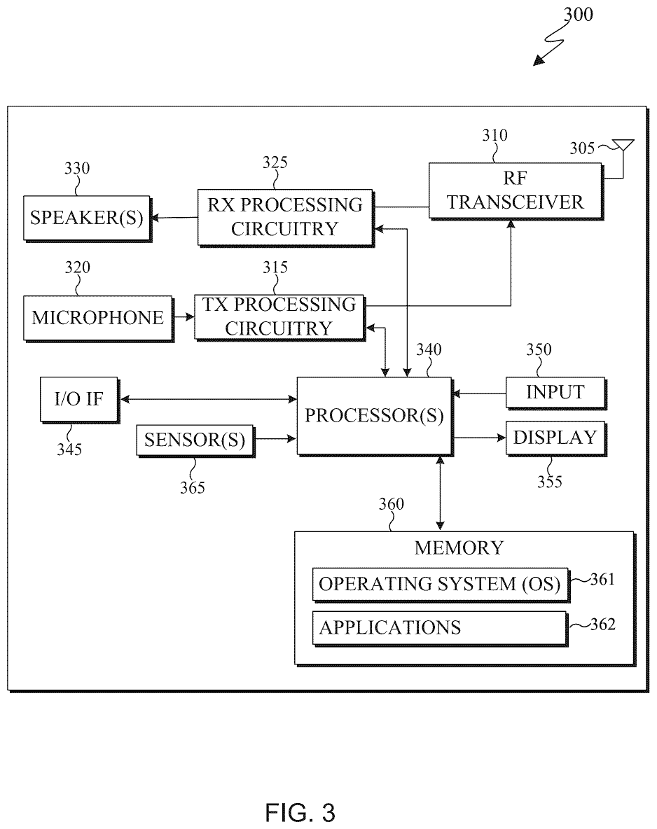

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 may a network entity or perform functions on behalf or entities in the network 102. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a qtemperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Various embodiments of the present disclosure recognize that energy conservation is a problem that every enterprise is looking to reduce the impact on global climate. Governments of different countries are also introducing legislations to force enterprises to conserve energy. Cellular network providers, network operators, application service providers are also looking at ways to conserve energy while deploying and providing next generation applications and services over 5G and 6G networks. Energy consumption measurement at different level of application processing in the mobile network chain is required for effective analysis of pain points for energy spending. Further, effective capabilities have to be developed to reduce the energy demands for these applications and services.

Accordingly, various embodiments of the present disclosure describe aspects related to: measuring energy consumption information at different entities in the 5G system to provide a feedback to those entities for energy savings for one or more UE applications; measuring energy consumption information at different granularities to provide optimization feedback to entities taking part in UE application traffic processing; a method for energy policy enforcement at different entities in the 5G System based on energy consumption measurement at different levels of application granularities; and recommended energy enforcement actions for different entities involved in processing or forwarding UE application traffic.

Various embodiments of the present disclosure further recognize that energy conservation in telecom and mobile networks is an area of concern. As more and more users attempt to avail themselves of the benefits of mobile networks, network operators and application service providers are having to deploy and run many network functions within the mobile network and remote cloud. As complexity of mobile applications is growing with 5G and next generation 6G networks, higher computing resources are being deployed at multiple levels. This is leading to energy increase in and outside the mobile network. To reduce and conserve energy, mobile network operators and application service providers are researching and designing energy conservation mechanisms to manage one or more applications not only in the network, but also in the user terminal devices. This disclosure describes methods for QoS management for one or more applications in the UE and the mobile network operator during energy conservation tasks.

Accordingly, various embodiments of the present disclosure describe aspects related to: application tolerance when conserving energy during delivery of application sessions to end user terminals; QoS management of application sessions of one or more applications in the UE or the mobile network during energy conservation tasks in 5G and 6G networks; a procedure for configuration and use of tolerance information for application groups for QoS adjustment processes; and a procedure for QoS degradation of application sessions of one or more applications due to energy constraints.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

The present disclosure describes aspects related to using 5G Media Streaming. A description of some of the functions described in this disclosure are follows:
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.
5GMS ASP: Application Service Provider that provides 5G Media Streaming services to subscribed users using 5GMS system. Hereafter, in this disclosure, may also be referred to as Application Service Provider or ASP.

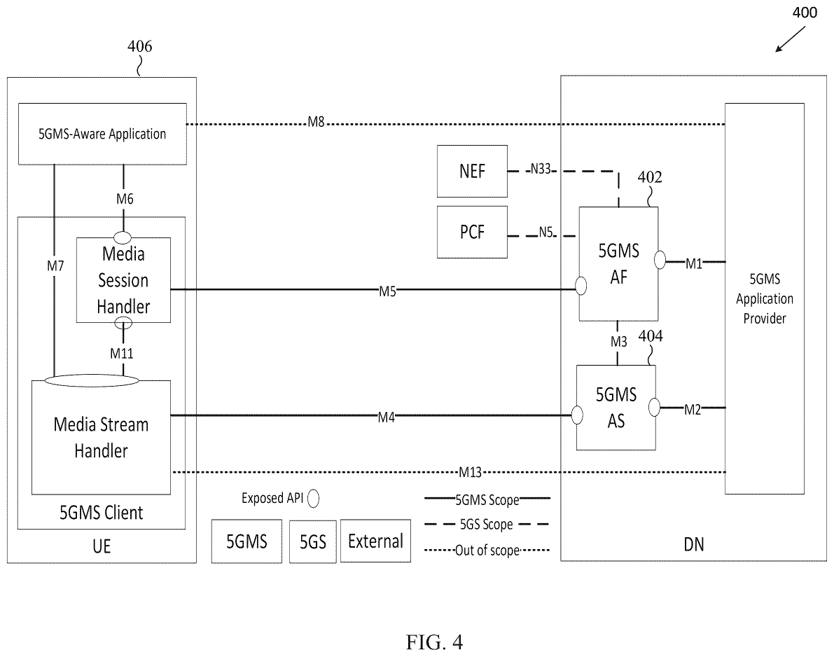

FIG. 4 illustrates an example 5GMS architecture 400 according to embodiments of the present disclosure. The embodiment of a 5GMS architecture of FIG. 4 is for illustration only. Different embodiments of a 5GMS architecture could be used without departing from the scope of this disclosure.

As shown in FIG. 4, media services can be provisioned by an application service provider at a 5G AF 402 using the M1 interface and content is ingested to a 5G AS 404 using the M2 interface. After any processing to the ingested media (as provisioned by the application service provider and enforced by the 5G AF), the content is then distributed to end users using the M4 interface. The end user device UE 406 uses M5 interface to communicate back with the control and user plane functions (i.e., the 5G AF and 5G AS) in the core network.

3GPP TR 26942 describes the study aspects of energy consumption and exposure related to media applications in 3GPP end user devices. This technical report presents a number of studies related to collection and exposure of energy consumption information at OAM, NF (network function), and from individual UEs (e.g., using the UE data collection, reporting and event exposure functionalities specified in TS 26531 and TS 26532). The technical report also describes energy consumption and exposure studies and efforts in other standard forums such as ITU-T, ITU-R, MPEG, DVB, ATSC, ETSI, and other industries such as Greening of Streaming, DIMPACT, and Ultra HD Forum. The technical report specifies use cases for energy consumption reporting, and key issues and solutions related to energy information exposure, monitoring and measurement, and evaluation framework in media applications.

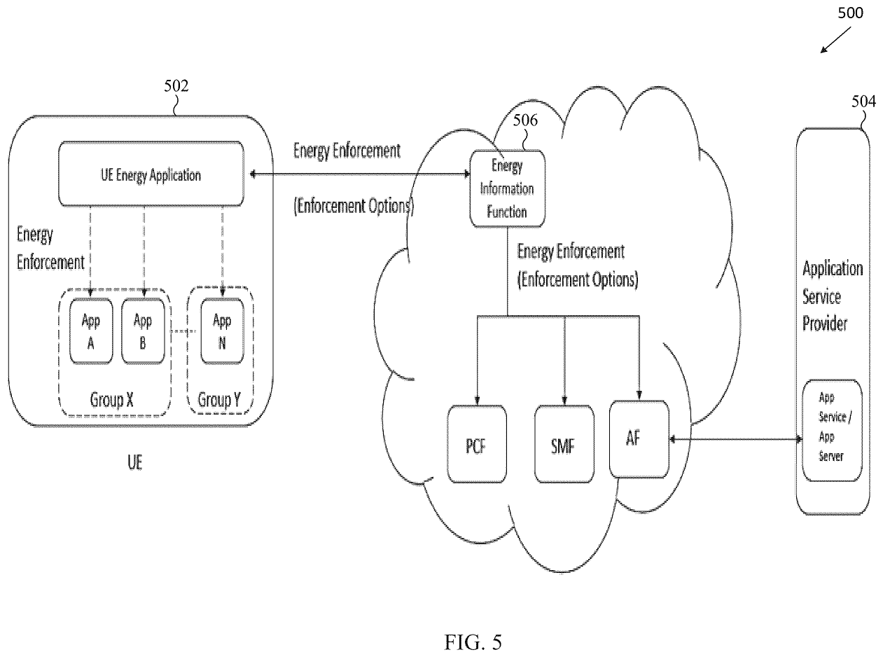

FIG. 5 illustrates an example energy policy enforcement 500 according to embodiments of the present disclosure. The embodiment of an energy policy enforcement of FIG. 5 is for illustration only. Different embodiments of an energy policy enforcement could be used without departing from the scope of this disclosure.

Once the EIF 506 receives energy consumption information from the UE 502, network functions, and application services/application services 504, either directly, or via Energy Service Directory, using procedures described herein, the EIF 506 may take active part in enforcing energy policies as shown in FIG. 5.

As shown in FIG. 5, the Energy Information Function 506 may take active part in Energy policy enforcement in the network. The table below describes different enforcement options at different entities to enforce energy policies by the Energy Information Function 506.

| Enforced | |
|---|---|
| at entity | Enforcement Details |
| Network | The Energy Information Function may send a request |
| Functions | to SMF and/or AF to perform the following energy |
| | enforcement actions: |
| | Request to terminate all applications associated |
| | with the UE. In this case, the EIF includes the UE |
| | identification information so the network functions |
| | may identify the intended UEs |
| | Request to terminate a specific application associated |
| | with the UE. In this case, the EIF includes the |
| | application identification information, and the UE |
| | identification information so the network functions |
| | may identify the intended UEs and the applications |
| | Request to terminate a specific PDU Session associated |
| | with the UE. In this case, the EIF includes the PDU Session |
| | identification information, and the UE identification |
| | information so the network functions may identify the |
| | intended UEs and the PDU Sessions |
| | Request to terminate a specific application flow of a |
| | specific application associated with the UE. In this case, |
| | the EIF includes the application flow identification, |
| | application identification information, and the UE |
| | identification information so the network functions may |
| | identify the intended UEs and the specific application |
| | flows of specific applications |
| | Request to terminate a application group associated |
| | with the UE. In this case, the EIF includes the |
| | application group identification information, and the |
| | UE identification information so the network |
| | functions may identify the intended UEs and the |
| | application group |
| | Request to terminate all application traffic associated |
| | with the UE over a specific network slice and/or data |
| | network. In this case, the EIF includes the network |
| | slice and/or data network information, and the UE |
| | identification information so the network functions may |
| | identify the intended UE traffic over the network slice |
| | and/or DNN |
| UE | The Energy Information Function may send a request to |
| | UE Energy Application to perform the following energy |
| | enforcement actions: |
| | Request to stop all traffic of all applications associated |
| | with the UE to be sent to the operator network. |
| | Request to stop traffic of a specific application associated |
| | with the UE. In this case, the EIF includes the application |
| | identification information so the UE Energy Application |
| | may identify the specific application |
| | Request to terminate a specific PDU Session associated |
| | with the UE. In this case, the EIF includes the PDU |
| | Session identification information so the UE Energy |
| | Application may identify all the applications |
| | associated with the PDU Session |
| | Request to terminate a specific application flow of a |
| | specific application associated with the UE. In this |
| | case, the EIF includes the application flow |
| | identification, and the application identification |
| | information so the UE Energy Application may |
| | identify the specific application flows of specific |
| | applications |
| | Request to terminate an application group associated |
| | with the UE. In this case, the EIF includes the |
| | application group identification information so the |
| | UE Energy Application may identify the application |
| | group. After identifying the application group, the UE |
| | Energy Application may infer the associated applications |
| | inside the application group, and perform the requested |
| | enforcement action for each application inside the |
| | application group. |
| | Request to terminate all application traffic associated |
| | with the UE over a specific network slice and/or data |
| | network. In this case, the EIF includes the network |
| | slice and/or data network information so the UE |
| | Energy Application may identify the list of all applications |
| | using the specific network slice and/or data network. |
| | The UE Energy Application may then perform the |
| | requested energy enforcement action for each |
| | application using the given network slice and/or data |
| | network. |
| Application | The Energy Information Function may send a request to |
| Service/ | AF to perform the following energy enforcement actions: |
| Application | Request to stop all applications associated with a given UE. |
| Server | The EIF may include the UE identification information in |
| | this request to the AF. The AF may then forward this |
| | information to the Application Service Provider using |
| | an existing interface (e.g., M1 interface specified in TS |
| | 26.501. The Application Service provider, may then stop |
| | all application traffic associated with the given UE |
| | identification |
| | Request to stop traffic of a specific application associated |
| | with the UE. The EIF may include the UE identification |
| | information, and the application identification information, |
| | in this request to the AF. The AF may then forward this |
| | information to the Application Service Provider using |
| | an existing interface (e.g., M1 interface specified in TS |
| | 26.501. The Application Service provider, may then |
| | stop specific application traffic associated with the given |
| | UE identification at the Application Service/Application |
| | Server. |
| | Request to terminate a specific transport session |
| | associated with the UE. The EIF may include the UE |
| | identification information, transport session information, |
| | in this request to the AF. The AF may then forward this |
| | information to the Application Service Provider using an |
| | existing interface (e.g., M1 interface specified in TS |
| | 26.501. The Application Service provider, may then |
| | stop all applications over the given transport session |
| | associated with the given UE identification at the |
| | Application Service/Application Server. |
| | Request to terminate a specific application flow of a |
| | specific application associated with the UE. The EIF |
| | may include the UE identification information, |
| | application identification information, application |
| | flow identification information, in this request to the |
| | AF. The AF may then forward this information to the |
| | Application Service Provider using an existing interface |
| | (e.g., M1 interface specified in TS 26.501. The |
| | Application Service provider, may then stop application |
| | flow associated with the given application associated |
| | with the given UE identification at the Application |
| | Service/Application Server. |
| | Request to terminate an application group associated |
| | with the UE. The EIF may include the UE identification |
| | information, and the application group information, in |
| | this request to the AF. The AF then infers the list of all |
| | applications in the application group. The AF may then |
| | forward this information to the Application Service |
| | Provider using an existing interface (e.g., M1 interface |
| | specified in TS 26.501. The Application Service |
| | provider, may then stop all application traffic |
| | associated with the given UE identification at the |
| | Application Service/Application Server. |
| | Request to terminate all application traffic associated |
| | with the UE over a specific network slice and/or data |
| | network. The EIF may include the UE identification |
| | information, network slice and/or data network |
| | information, in this request to the AF. The AF then |
| | infers the list of all UE applications using the provided |
| | network slice and/or the data network. The AF may |
| | then forward this information to the Application |
| | Service Provider using an existing interface (e.g., M1 |
| | interface specified in TS 26.501. The Application |
| | Service provider, may then stop all applications |
| | associated with the given UE identification at the |
| | Application Service/Application Server. |

Described herein is a procedure for energy enforcement by the EIF at either the UE, network functions, or the Application Services/Application Servers at different granularities (UE level, UE application level, UE application flow level, UE PDU Session level, UE application group level, and network slice/data network level. The procedures described herein use an example energy enforcement action of terminating/stopping for the enforcement procedure.

Below, in this embodiment, described are different energy enforcement procedures at different levels and different granularities.

The proposed enforcement methods include:
1) Stop: Enforcement method is to stop the traffic corresponding to this level. If this action is enforced/adopted, the traffic may be started again at this level when a new enforcement method command to start at this level is issued by the EIF
2) Start: Enforcement method is to start the traffic corresponding to this level.
3) Restart: Enforcement method is to stop and start the traffic corresponding to this level.
   a. When this enforcement method is suggested, the enforcement information may also include the amount of time to wait before starting
4) Terminate: Enforcement method is to terminate the entities that are processing traffic corresponding to this level.
5) None: No Enforcement method is possible at the given level

| Entity | Level | Supported Enforcement Actions/Methods |
|---|---|---|
| UE | Host | None |
| UE | Application | Stop: Stop specific application from |
| | | issuing traffic to the operator network. |
| | | When this enforcement method is issued, |
| | | the UE Energy Application may |
| | | collaborate with the application to |
| | | temporarily stop the application or |
| | | terminate the instance |
| | | Start: Allow the specific application to |
| | | issue traffic to the operator network. |
| | | Restart: Instruct the application to restart |
| | | the application flows and traffic of this |
| | | application to the operator network |
| | | Terminate: Instruct the UE to terminate the |
| | | application. When this enforcement |
| | | method is issued, the UE Energy |
| | | Application may collaborate with the |
| | | application and host operating system to |
| | | terminate the application instance. The |
| | | application may be restarted by the end |
| | | user if the end user chooses to do so. |
| UE | Application | Stop: Stop specific application flow from |
| | Flow | issuing traffic to the operator network. |
| | | When this enforcement method is issued, |
| | | the UE Energy Application may |
| | | collaborate with the application to |
| | | temporarily stop the application flow |
| | | Start: Allow the specific application to |
| | | issue traffic of the given application flow |
| | | to the operator network. |
| | | Restart: Instruct the application to restart a |
| | | specific application flow |
| | | Terminate: Instruct the application to |
| | | terminate specific application flow of a |
| | | specific application. |
| UE | PDU | Stop: Stop specific PDU Session traffic to |
| | Session | the operator network. |
| | | Start: Allow the specific PDU Session |
| | | traffic to the operator network. |
| | | Restart: Instruct the UE to restart a specific |
| | | PDU Session |
| | | Terminate: Instruct the UE to terminate a |
| | | specific PDU Session |
| UE | Network | Stop: Stop specific Network slice/data |
| | slice | network traffic to the operator network. |
| | and/or | Start: Allow the specific slice/data network |
| | Data | traffic to the operator network. |
| | Network | Restart: Instruct the UE to restart a specific |
| | | slice/data network |
| | | Terminate: Instruct the UE to terminate a |
| | | specific slice/data network. When this |
| | | method is enforced, the UE may have to |
| | | switch any of the application flows in this |
| | | network slice to a different network slice. |
| | | For this purpose, the UE may collaborate |
| | | with SMF to change its network slice. |
| | | Optionally, the EIF may request PCF |
| | | and/or SMF to perform the network slice |
| | | replacement procedure described in TS |
| | | 23.501 |
| UE | Application | Stop: Stop all the applications in the give |
| | Group | application group. |
| | | Start: Allow all the applications in the |
| | | given application group to issue traffic to |
| | | the operator network. |
| | | Restart: Instruct the UE to restart all the |
| | | applications in the given application group |
| | | Terminate: Instruct the UE to terminate all |
| | | the applications in the given application |
| | | group. When this enforcement method is |
| | | issued, the UE Energy Application may |
| | | collaborate with each of the applications in |
| | | the application group, and host operating |
| | | system, to terminate their instances. The |
| | | application group may be restarted by the |
| | | end user if the end user chooses to do so. |
| Network | Host | Stop: The EIF may instruct the 3GPP |
| Functions | | management functions to stop specific |
| (e.g., any | | network function for energy management |
| of PCF, | | purposes. |
| SMF, AF, | | Start: Allow the specific network function |
| NEF, | | to be started so it can begin processing of |
| AMF | | application traffic within the operator |
| etc.) | | network. |
| | | Restart: Instruct the 3GPP management |
| | | functions to restart the network functions |
| | | so they can restart processing any |
| | | application processing to help with energy |
| | | management. |
| | | Terminate: Instruct the 3GPP management |
| | | functions to terminate the network |
| | | function. The 3GPP management functions |
| | | may make new decisions to instantiate a |
| | | new instance of this network functions to |
| | | help with energy management |
| | | functionalities. |
| Network | Application | Stop: Instruct the Network Function(s) to |
| Functions | | stop processing traffic of specific UE |
| (e.g. ,any | | application for energy management |
| of PCF, | | purposes. |
| SMF, AF, | | Start: Instruct the Network Function(s) to |
| NEF, | | start processing traffic of specific UE |
| AMF | | application. |
| etc.) | | Restart: Instruct the Network Function(s) |
| | | to restart processing traffic of specific UE |
| | | application for energy management |
| | | purposes. |
| | | Terminate: Instruct the Network |
| | | Function(s) to not process traffic of |
| | | specific UE application for energy |
| | | management purposes until otherwise told |
| | | to do so. |
| Network | Application | Stop: Instruct the Network Function(s) to |
| Functions | Flow | stop processing traffic of specific |
| (e.g., any | | application flow of specific UE application |
| of PCF, | | for energy management purposes. |
| SMF, AF, | | Start: Instruct the Network Function(s) to |
| NEF, | | start processing traffic of specific |
| AMF | | application flow of specific UE |
| etc.) | | application. |
| | | Restart: Instruct the Network Function(s) |
| | | to restart processing traffic of specific |
| | | application flow of specific UE |
| | | application. |
| | | Terminate: Instruct the Network |
| | | Function(s) to not process traffic of |
| | | specific application flow of specific UE |
| | | application for energy management |
| | | purposes until otherwise told to do so. |
| Network | PDU | Stop: Instruct the Network Function(s) to |
| Functions | Session | stop processing traffic of specific PDU |
| (e.g., any | | Sessions for energy management purposes. |
| of PCF, | | Start: Instruct the Network Function(s) to |
| SMF, AF, | | start processing traffic of specific PDU |
| NEF, | | Sessions. |
| AMF | | Restart: Instruct the Network Function(s) |
| etc.) | | to restart processing traffic of specific |
| | | PDU Sessions. |
| | | Terminate: Instruct the Network |
| | | Function(s) to not process traffic of |
| | | specific PDU Sessions for energy |
| | | management purposes until otherwise told |
| | | to do so. |
| Network | Network | Stop: Instruct the Network Function(s) to |
| Functions | slice | stop processing traffic of all traffic within |
| (e.g., any | and/or | specific network slice and/or data network |
| of PCF, | Data | for energy management purposes. |
| SMF, AF, | Network | Start: Instruct the Network Function(s) to |
| NEF, | | start processing traffic of all traffic within |
| AMF | | specific network slice and/or data network. |
| etc.) | | Restart: Instruct the Network Function(s) |
| | | to restart processing traffic of all traffic |
| | | within specific network slice and/or data |
| | | network. |
| | | Terminate: Instruct the Network |
| | | Function(s) to not process traffic of all |
| | | traffic within specific network slice and/or |
| | | data network for energy management |
| | | purposes until otherwise told to do so. |
| Network | Application | Stop: Instruct the Network Function(s) to |
| Functions | Group | stop processing traffic of all applications |
| (e.g., any | | within the application group of specific UE |
| of PCF, | | for energy management purposes. |
| SMF, AF, | | Start: Instruct the Network Function(s) to |
| NEF, | | start processing traffic of all applications |
| AMF | | within the application group of specific |
| etc.) | | UE. |
| | | Restart: Instruct the Network Function(s) |
| | | to restart processing traffic of all |
| | | applications within the application group |
| | | of specific UE. |
| | | Terminate: Instruct the Network |
| | | Function(s) to not process traffic of all |
| | | applications within the application group |
| | | of specific UE for energy management |
| | | purposes until otherwise told to do so. |
| Application | Host | Stop: Instruct the Application |
| Service/ | | Service/Application Server to stop |
| Application | | processing traffic of all applications of |
| Server | | a specific UE for energy management |
| | | purposes. |
| | | Start: Instruct the Application |
| | | Service/Application Server to start |
| | | processing traffic of all applications of |
| | | a specific UE for energy management |
| | | purposes. |
| | | Restart: Instruct the Instruct the |
| | | Application Service/Application Server to |
| | | restart processing traffic of all applications |
| | | of a specific UE for energy management |
| | | purposes. |
| | | Terminate: Instruct the Application |
| | | Service/Application Server to terminate |
| | | processing traffic of all applications of a |
| | | specific UE for energy management |
| | | purposes until otherwise told to do so. |
| | | For any of the actions here, the EIF may |
| | | instruct the AF one or more of the above |
| | | enforcement methods, and the AF may |
| | | interact with Application Service Provider |
| | | using the M1 interface specified in TS |
| | | 26501 to perform the enforcement for |
| | | this level. |
| Application | Application | Stop: Instruct the Application |
| Service/ | | Service/Application Server to stop |
| Application | | processing traffic of specific |
| Server | | application of a specific UE for energy |
| | | management purposes. |
| | | Start: Instruct the Application |
| | | Service/Application Server to start |
| | | processing traffic of specific |
| | | application of a specific UE for |
| | | energy management purposes. |
| | | Restart: Instruct the Application |
| | | Service/Application Server to restart |
| | | processing traffic of specific |
| | | application of a specific UE for energy |
| | | management purposes. |
| | | Terminate: Instruct the Application |
| | | Service/Application Server to terminate |
| | | processing traffic of specific application of |
| | | a specific UE for energy management |
| | | purposes until otherwise told to do so. |
| | | For any of the actions here, the EIF may |
| | | instruct the AF one or more of the |
| | | above enforcement methods, and the |
| | | AF may interact with Application Service |
| | | Provider using the M1interface specified |
| | | in TS 26501 to perform the enforcement |
| | | for this level. |
| Application | Application | Stop: Instruct the Application |
| Service/ | Flow | Service/Application Server to stop |
| | | processing traffic of specific |
| Application | | application flow of specific |
| Server | | application of a specific UE for |
| | | energy management purposes. |
| | | Start: Instruct the Application |
| | | Service/Application Server to start |
| | | processing traffic of specific |
| | | application flow of specific |
| | | application of a specific UE for |
| | | energy management purposes. |
| | | Restart: Instruct the Instruct the |
| | | Application Service/Application Server |
| | | to restart processing traffic of specific |
| | | application flow of specific application |
| | | of a specific UE for energy |
| | | management purposes. |
| | | Terminate: Instruct the Application |
| | | Service/Application Server to terminate |
| | | processing traffic of specific application |
| | | flow of specific application of a specific |
| | | UE for energy management purposes |
| | | until otherwise told to do so. |
| | | For any of the actions here, the EIF |
| | | may instruct the AF one or more of |
| | | the above enforcement methods, and |
| | | the AF may interact with Application |
| | | Service Provider using the M1 interface |
| | | specified in TS 26501 to perform the |
| | | enforcement for this level. |
| Application | PDU | Stop: Instruct the Application |
| Service/ | Session | Service/Application Server to stop |
| Application | | processing traffic of specific transport |
| Server | | session for energy management |
| | | purposes. |
| | | Start: Instruct the Application |
| | | Service/Application Server to start |
| | | processing traffic of specific transport |
| | | session fo renergy management |
| | | purposes. |
| | | Restart: Instruct the Instruct the |
| | | Application Service/Application Server to |
| | | restart processing traffic of specific |
| | | transport session for energy management |
| | | purposes. |
| | | Terminate: Instruct the Application |
| | | Service/Application Server to terminate |
| | | processing traffic of specific transport |
| | | session for energy management purposes |
| | | until otherwise told to do so. |
| | | For any of the actions here, the EIF |
| | | may instruct the AF one or more of the |
| | | above enforcement methods, and the |
| | | AF may interact with Application |
| | | Service Provider using the M1 |
| | | interface specified in TS 26501 to perform |
| | | the enforcement for this level. |
| Application | Network | Stop: Instruct the Application |
| Service/ | slice | Service/Application Server to stop |
| Application | and/or | processing traffic of applications over |
| Server | Data | specific network slice and/or data |
| | Network | network for energy management |
| | | purposes. |
| | | Start: Instruct the Application |
| | | Service/Application Server to start |
| | | processing traffic of applications over |
| | | specific network slice and/or data |
| | | network for energy management |
| | | purposes. |
| | | Restart: Instruct the Instruct the |
| | | Application Service/Application Server to |
| | | restart processing traffic of applications |
| | | over specific network slice and/or data |
| | | network for energy management purposes. |
| | | Terminate: Instruct the Application |
| | | Service/Application Server to terminate |
| | | processing traffic of applications over |
| | | specific network slice and/or data network |
| | | for energy management purposes until |
| | | otherwise told to do so. |
| | | For any of the actions here, the EIF may |
| | | instruct the AF one or more of the above |
| | | enforcement methods, and the AF may |
| | | interact with Application Service |
| | | Provider using the M1 interface specified |
| | | in TS 26501 to perform the enforcement |
| | | for this level. |
| Application | Application | Stop: Instruct the Application |
| Service/ | Group | Service/Application Server to stop |
| Application | | processing traffic of all applications in |
| Server | | the application group for energy |
| | | management purposes. |
| | | Start: Instruct the Application |
| | | Service/Application Server to start |
| | | processing traffic of all applications |
| | | in the application group for energy |
| | | management purposes. |
| | | Restart: Instruct the Instruct the |
| | | Application Service/Application Server to |
| | | restart processing traffic of all applications |
| | | in the application group for energy |
| | | management purposes. |
| | | Terminate: Instruct the Application |
| | | Service/Application Server to stop |
| | | processing traffic of all applications |
| | | in the application group for energy |
| | | management purposes until |
| | | otherwise told to do so. |
| | | For any of the actions here, the EIF |
| | | may instruct the AF one or more of |
| | | the above enforcement methods, and |
| | | the AF may interact with Application |
| | | Service Provider using the M1 interface |
| | | specified in TS 26501 to perform the |
| | | enforcement for this level. |

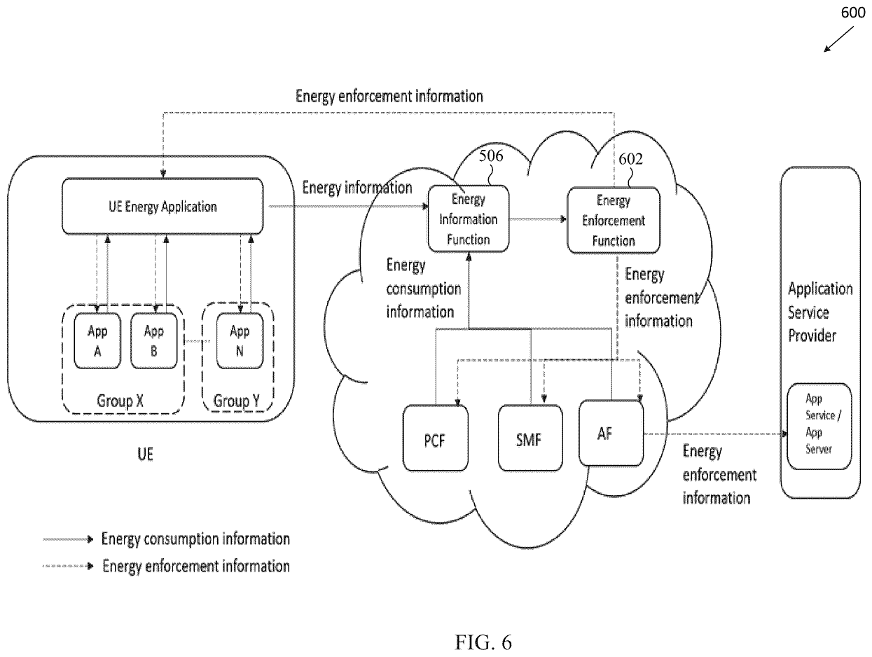

FIG. 6 illustrates an example energy policy enforcement function in an operator network 600 according to embodiments of the present disclosure. The embodiment of an energy policy enforcement function of FIG. 6 is for illustration only. Different embodiments of an energy policy enforcement function could be used without departing from the scope of this disclosure.

Described above are procedures where an existing 3GPP specified network function, called Energy Information Function, implements the energy enforcement functionalities described in this disclosure. In an alternative embodiment, a different function, called the Energy Enforcement Function 602, may perform the role of energy enforcement, while the Energy Information Function 506 just performs the role of energy information collection. In this case, the Energy Information Function 506, once it collects the energy consumption information from several entities described in this disclosure, may provide the information to the Energy Enforcement Function 602, which performs the tasks of energy enforcement procedures described in this disclosure. The architecture diagram is as shown in FIG. 6.

As shown in FIG. 6, the Energy Information Function 506 collects information from different entities in the 5G System such as from the UE, network functions, and the application service/application server. The Energy Information Function 506 may then generate energy consumption information as described in this disclosure, and then forward that energy information to the Energy Enforcement Function 602.

As described herein, the energy information sent from the Energy Information Function 506 to the Energy Enforcement Function 602 could be of different granularities (such as the host level including UE and Network Function level, application level, application flow level, PDU Session and/or transport session level, network slice and/or data network level, and application service/application server level) as described herein. In turn the Energy Enforcement Function 602 performs energy enforcement actions for different granularities as described herein.

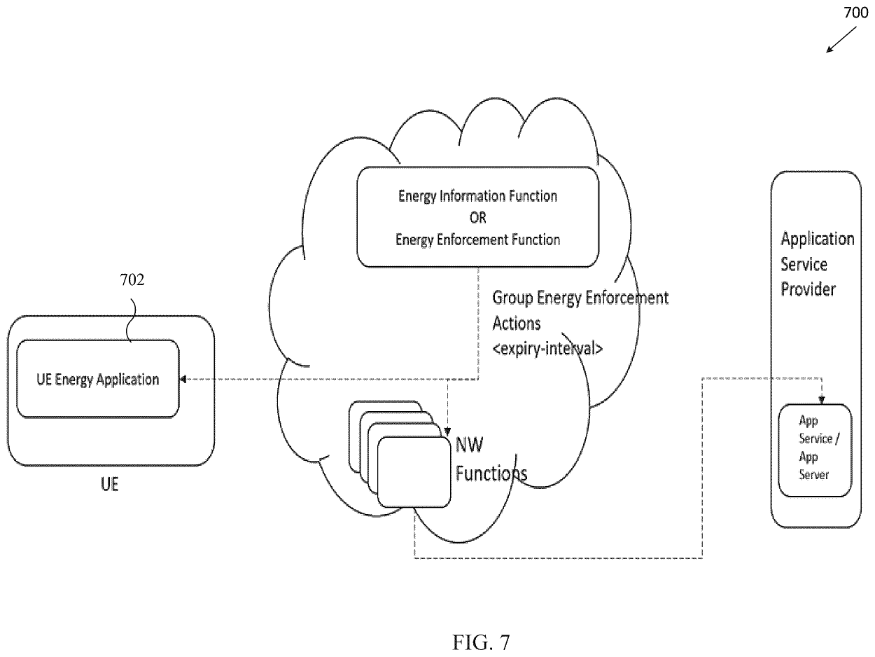

FIG. 7 illustrates an example energy policy enforcement function with expiry information 700 according to embodiments of the present disclosure. The embodiment of an energy policy enforcement function with expiry information of FIG. 7 is for illustration only. Different embodiments of an energy policy enforcement function with expiry information could be used without departing from the scope of this disclosure.

In an alternative embodiment, it is possible that the Energy Information Function may provide enforcement actions for a given time period. To facilitate this functionality, along with the enforcement action information, the EIF may also include an “expiry-interval” which represents the amount of time for which the provided enforcement actions are applicable. The Energy Information Function may send updated energy enforcement actions to the UE Energy Application 702 before the expiry of this interval. If for any reason, the updated energy enforcement actions does not reach the UE Energy Application 702 before the expiry of this interval, the applicability of energy enforcement actions expire, and are no longer applicable. In this case, the UE Energy Application 702 waits to hear back from the Energy Information Function to receive an updated energy enforcement actions information. The Energy Information Function may avoid sending energy enforcement actions information to the UE Energy Application 702 if it intends that the application group in the UE no longer needs to follow the enforcement actions.

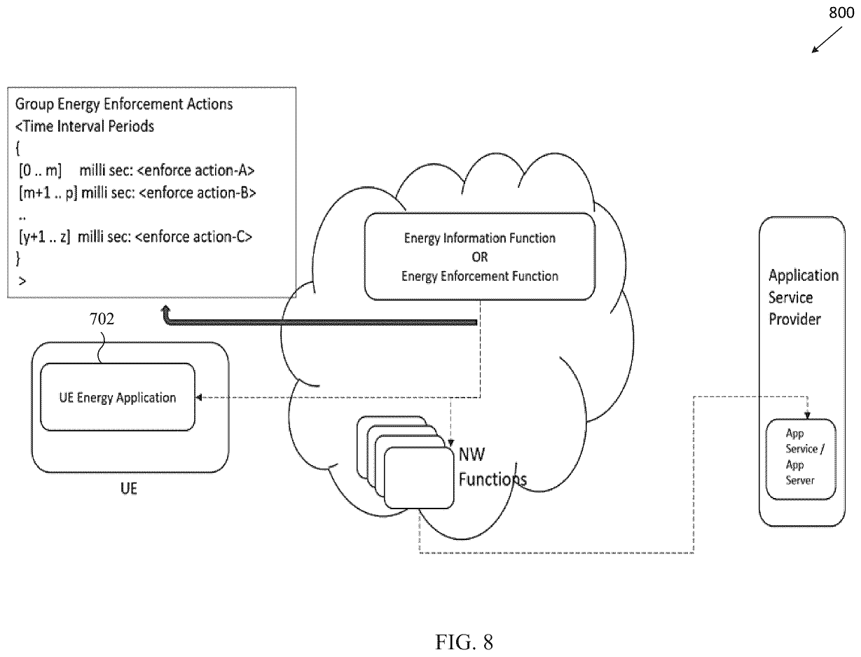

FIG. 8 illustrates an example energy policy enforcement function for multiple time periods 800 according to embodiments of the present disclosure. The embodiment of an energy policy enforcement function for multiple time periods of FIG. 8 is for illustration only. Different embodiments of an energy policy enforcement function for multiple time periods could be used without departing from the scope of this disclosure.

In an alternative embodiment, it is possible that the Energy Information Function may generate energy enforcement actions information for a number of time periods, and provide this information to the UE Energy Application 702 in the UE. To facilitate this procedure, the EIF may send the following information to the UE Energy Application 702 to indicate energy enforcement actions information over multiple time periods:

| Time Period | Energy Enforcement Actions |
|---|---|
| [0 − m] milli seconds | < energy enforcement actions information a> |
| [m + 1 − p] milli seconds | < energy enforcement actions information b> |
| . . . | . . . |
| [y + 1 − z] milli seconds | < energy enforcement actions information c> |

The above information may be provided by the Energy Information Function to the UE Energy Application to request for energy enforcement actions for different time periods.

The time periods in the above table may not be uniformly distributed. It is up to the network operator, Application Function, Energy Information Function, to specify the duration of each time period.

The Energy Information Function may then send updated energy enforcement actions information as described herein if it intends to send the target information for a specific period of time.

Optionally, the Energy Information Function may send updated energy enforcement actions information for a number of time periods as described herein.

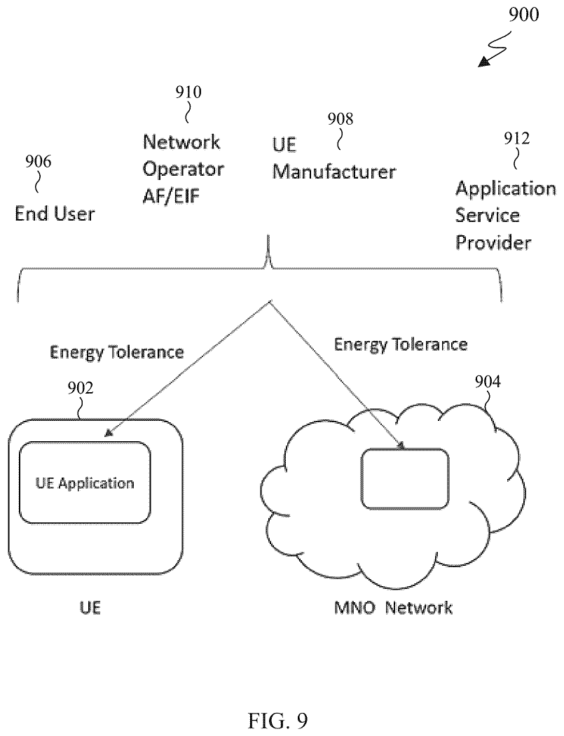

FIG. 9 illustrates an example configuration of application tolerance for reduced service quality due to energy constraints 900 according to embodiments of the present disclosure. The embodiment of an example configuration of application tolerance for reduced service quality due to energy constraints of FIG. 9 is for illustration only. Different embodiments of an example configuration of application tolerance for reduced service quality due to energy constraints could be used without departing from the scope of this disclosure.

In some embodiments, applications on the UE may be configured with tolerance values that signify the extent to which the service quality of applications may be lowered because of energy constraints.

Application tolerance may be statically configured on the device by the end user, network operator, application service provider, or the UE manufacturer. Application tolerance may also be dynamically configured and modified by the network operator or an application service provider.

The application tolerance may be configured at the UE 902, or at a network function in the MNO network 904 (e.g., Application Function or Energy Information Function). The network function in the MNO network 904 may further interact with other network functions in the MNO network to facilitate the application tolerance as described in this disclosure.

The end user 906 may manually update the application tolerance as and when needed. The UE manufacturer may provide a one-time configuration of application tolerance, or update the value using a device update.

The network operator 910 and/or the application service provider 912, may use existing interfaces to configure application tolerance at the application on the UE 902. For example, the application service provider 912 may use the M1 interface specified in TS 26501 and TS 26510 to configure the application tolerance for an application on the UE 902 at the Application Function in the operator network. The network operator may then use M5 interface specified in TS 26501 and TS 26510 to configure the application tolerance for an application on the UE. The application service provider 912 may also use the M8 interface defined in TS 26501 and TS 26510 to configure the application tolerance for an application on the UE 902.

The following information may be included in the service configuration information that gets configured for an application service.

TABLE 1
Application Energy Tolerance Information

| Parameter | Description |
|---|---|
| Application- | A tolerance value that signifies how much the service |
| tolerance- | quality may be degraded for the UE application. |
| adjustment- | This is a single scalar value for cases when the service |
| value | quality degradation is performed on basis of a simple |
| | percentage drop off. |
| | For example, a value of 0.2 indicates that the service |
| | quality may be degraded up to a maximum of 20% |
| | from the peak maximum service quality value. |
| Service- | Level of service quality at which the above tolerance |
| quality-level | scalar value is to be checked for degrading. The |
| | service quality level can be any of the following: |
| | Application: The configured tolerance-value is |
| | at the level of the whole application. This |
| | option indicates that the application quality is |
| | to be checked and allowed to be degraded, up |
| | to the configured adjustment -value, because of |
| | energy constraints. |
| | PDU-Session: The configured tolerance-value |
| | is at the level of PDU session. This option |
| | indicates that the PDU session quality is to be |
| | checked and allowed to be degraded, up to the |
| | configured adjustment -value, because of |
| | energy constraints. |
| | flow: The configured tolerance-value is at the |
| | level of service flows. This option indicates |
| | that the PDU session quality is to be checked |
| | and allowed to be degraded, up to the |
| | configured adjustment-value, because of |
| | energy constraints |
| | Slice: The configured tolerance-value is at the |
| | level of network slices. This option indicates |
| | that the slice quality is to be checked and |
| | allowed to be degraded, up to the configured |
| | adjustment-value, because of energy |
| | constraints |
| Energy- | List of objects describing all the energy constraints. |
| constraints | Each member object of this list may include the |
| | following information: |
| | energy-constraint-id: Identifier assigned to this |
| | energy constraint object. The energy- |
| | constraint-id is used to correlate energy |
| | conditions to tolerance values (described next) |
| | parameter-low-threshold: Lower value of the |
| | energy range |
| | parameter-high-threshold: Higher value of the |
| | energy range |
| | parameter-name: parameter for which the |
| | range is considered |
| | The parameters could be any of the following: |
| | Batter level |
| | Energy Source |
| | Energy Capacity |
| | Energy Level |
| | Average Source Temperature |
| | Average CO2e emission |
| | Energy drain average |
| | Energy measurement time span |
| | Energy Consumption Rate |
| | Carbon Intensity |
| | Discharge rate |
| Application- | Map of tolerance values for different ranges of energy |
| tolerance- | constraints. Each element of the map is of the form |
| adjustment- | <key, value> pair where in: |
| value-map | key represents the energy constraint identifier |
| | describing the energy condition |
| | value represents the tolerance value if the |
| | energy condition represented by the energy |
| | constraint identifier is satisfied. The tolerance |
| | value has the following information |
| | range-adjustment-value: Scalar |
| | tolerance value for the given energy |
| | range |
| | range-service-quality-level: The levels |
| | at which the above range- adjustment - |
| | value is applicable for. The different |
| | types of service quality levels here is |
| | same as defined earlier in the |
| | embodiment. |
| | By specifying range-service-quality values and range- |
| | adjustment values for different energy conditions, it |
| | becomes possible that application service quality to be |
| | modified differently at different energy constraints. |
| | For example, with the following key and value: |
| | key pointing to an energy condition with |
| | following information: |
| | parameter-low-threshold: 0.2 |
| | parameter-high-threshold: 0.4 |
| | parameter-name: battery-level |
| | value: |
| | range- adjustment -value: 0.2 |
| | range-service-quality-level: PDU-Session |
| | For the above example values, the battery level of the |
| | UE can be checked to see if the energy availability is |
| | in between 20% - 40% range, then the service quality |
| | can be lowered by 20% at the PDU Session level. |
| | More values could be defined in this map. Another |
| | key, value pair in this map for example could be: |
| | key pointing to an energy condition with |
| | following information: 0 |
| | parameter-low-threshold: 0.1 |
| | parameter-high-threshold: 0.2 |
| | parameter-name: battery-level 0 |
| | value: |
| | range- adjustment-value: 0.6 |
| | range-service-quality-level: PDU-Session |
| | The above values signify that if the battery level of the |
| | UE i.e., the energy availability is in between 10%-20% |
| | range, then the service quality can be lowered by |
| | 60% at the PDU Session level instead of just the 20% |
| | with the previous key value example pair. |

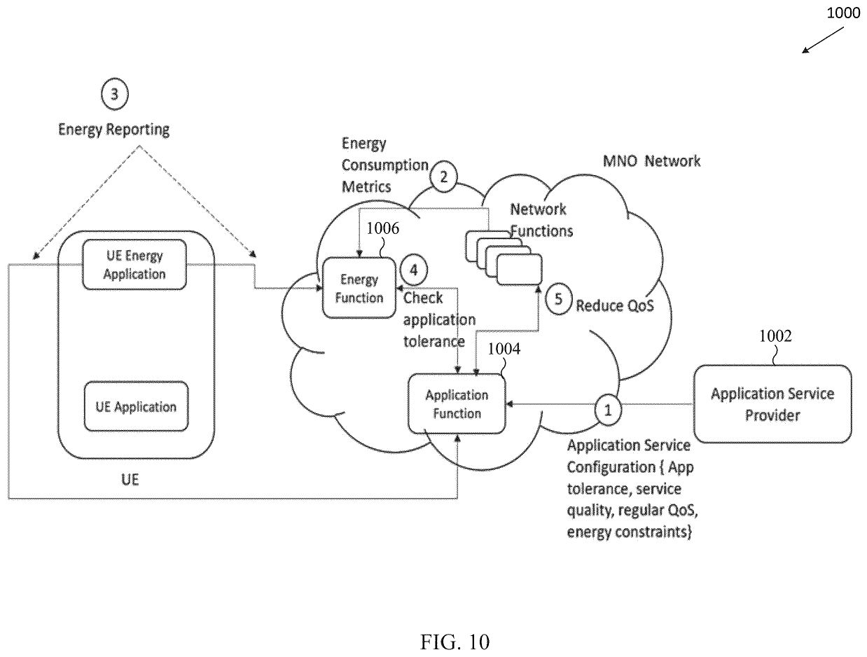

FIG. 10 illustrates an example procedure 1000 for degradation of application QoS due to energy constraints according to embodiments of the present disclosure. The embodiment of an example procedure for degradation of application QoS due to energy constraints of FIG. 10 is for illustration only. Different embodiments of an example procedure for degradation of application QoS due to energy constraints could be used without departing from the scope of this disclosure.

In one embodiment, a procedure for degradation of application QoS due to energy constraints attributed to the network is provided. In this procedure, an application service provider 1002 configures application energy tolerance information, QoS requirements for regular conditions, QoS requirements with energy constraints, and the conditions to satisfy the observation of energy constraints in the network. All of this information is used to degrade the QoS of application when energy constraints are observed.

The steps of the procedure 1000 include:
0. [Pre-requisite]: An application served by an application service provider is installed on the UE device. The UE device has the capability to report energy metrics to the network as described previously herein
1. The Application Service provider configures an application service at the Application Function 1004 in the operator network. The application service provider could use the M1 provisioning interface specified in TS 26501 and TS 26510 to configure the application service in the operator network. The service configuration from the application service provider includes the following details, in addition to the service configuration information specified in TS 26501 and TS 26510

| Parameter | Description |
|---|---|
| Application | Tolerance for application as defined earlier in the |
| energy | disclosure. The application energy tolerance |
| tolerance | information includes the information about energy |
| | conditions, and the amount of degradation to be |
| | applied at different levels |
| Regular QoS | QoS requirements as defined currently in TS 26501 |
| | and TS 26510 for the application |

When the above information is provisioned by the application service provider, the Application Function 1004 attempts to request provisioning of QoS as requested in ‘Regular QoS’ using existing procedures specified in TS 26501 and TS 26510.
2. Different network functions in the operator network monitor data traffic of the application and derive energy consumption information, and share it with Energy Function using existing procedures specified in TS 23501, TS 23502, and TS 23503.
3. The UE, or the UE Energy Application, shares the UE energy report or the Application Energy report with the Application Function 1004 or the Energy Function 1006. To share this information, the UE may use M5 interface specified in TS 26501 and TS 26510.
4. The Application Function 1004 and the Energy Function 1006 may check the application energy tolerance status to identify the need for QoS degradation. The following steps are performed in this check:
   a. Check the configured regular QoS requirements of the application
   b. Extract each energy condition from service configuration information and evaluate against the metrics data received from network functions and UE
   c. If any energy condition is satisfied i.e., if the derived energy consumption metrics show that certain energy condition is true, then extract the QoS degradation at the indicated service quality level with the indicated adjustment value.
   d. Repeat for all other energy conditions
5. Use the extracted QoS degradations at different service quality levels to perform overall QoS degradation for the application. To enforce the QoS degradation, the Application Function 1004 interacts with the network functions (e.g., PCF, SMF, etc.) to establish the degraded QoS at different service quality levels.

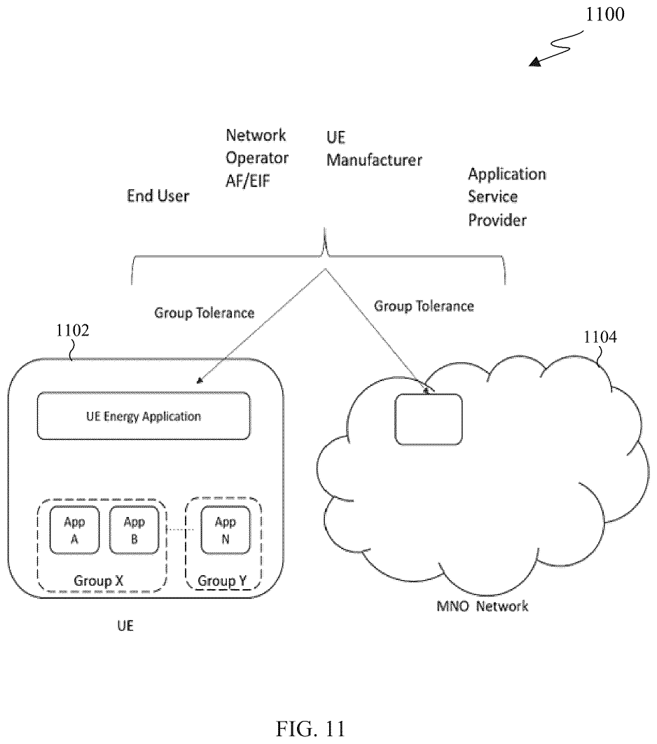

FIG. 11 illustrates an example configuration of group tolerance for reduced service quality due to energy constraints 1100 according to embodiments of the present disclosure. The embodiment of an example configuration of group tolerance for reduced service quality due to energy constraints of FIG. 11 is for illustration only. Different embodiments of an example configuration of group tolerance for reduced service quality due to energy constraints could be used without departing from the scope of this disclosure.

As shown in FIG. 11, the group tolerance may be configured at the UE 1102, or at a network function in the MNO network 1104 (e.g., Application Function or Energy Information Function). The network function in the MNO network 1104 may further interact with other network functions in the MNO network to facilitate the group tolerance as described in this disclosure.

As described herein, entities such as the end user, network operator, UE manufacturer, and the application service provider may configure tolerance values to application energy groups.

Group tolerance may be statically configured on the device by the end user, network operator, application service provider, or the UE manufacturer after defining application energy groups. Group tolerance may also be dynamically configured and modified by the network operator or an application service provider.

The end user may manually update the group tolerance as and when needed. The UE manufacturer may provide a one-time configuration of group tolerance, or update the value using a device update.

The network operator and/or the application service provider, may use existing interfaces to configure group tolerance at the UE Energy Application on the UE. For example, application service provider may use the M1 interface specified in TS 26501 and TS 26510 to configure the tolerance for an application energy group on the UE at the Application Function in the operator network. The network operator may then use M5 interface specified in TS 26501 and TS 26510 to configure the tolerance for an application energy group on the UE. The application service provider may also use the M8 interface defined in TS 26501 and TS 26510 to configure the tolerance for an application energy group on the UE.

The following information may be included in the group tolerance that gets configured for an application energy group on the UE

| Parameter | Description |
|---|---|
| Group Id | Identifier of application energy group |
| Application | Collection of application energy tolerances of all |
| energy | individual applications in the application energy |
| tolerance | group. |
| collection | Each entity in this collection has similar |
| | information as the application energy tolerance |
| | information described earlier in the disclosure. |
| Group | A simple scalar value considering all the |
| tolerance | tolerance scalar values of individual applications |
| value | in the application energy group. |

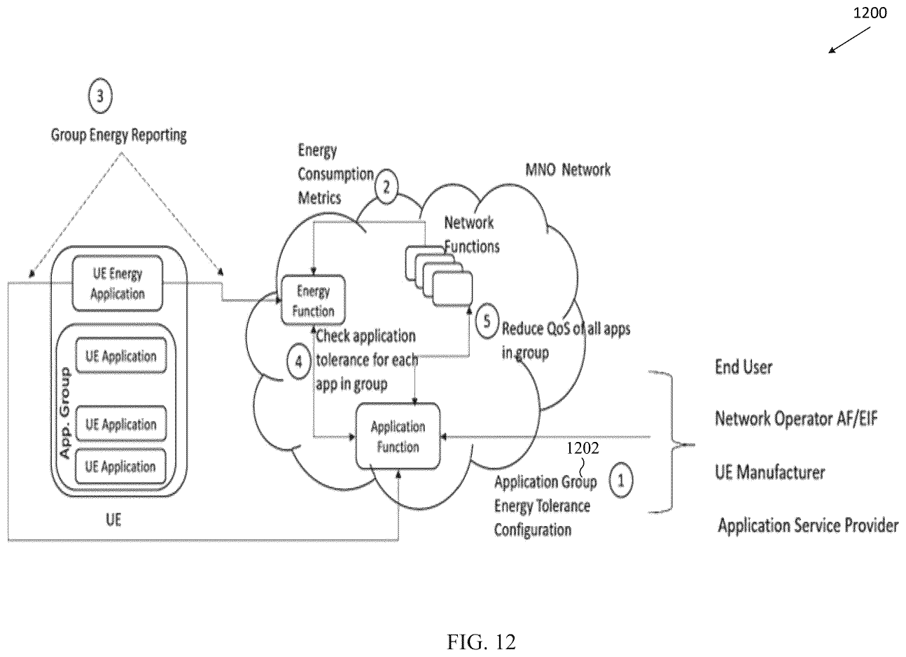

FIG. 12 illustrates an example procedure 1200 for QoS degradation of applications in groups due to energy constraints on one or more individual applications according to embodiments of the present disclosure. The embodiment of an example procedure for QoS degradation of applications in groups due to energy constraints on one or more individual applications of FIG. 12 is for illustration only. Different embodiments of an example procedure for QoS degradation of applications in groups due to energy constraints on one or more individual applications could be used without departing from the scope of this disclosure.

As shown in FIG. 12, an application group energy tolerance information 1202 is configured at the UE or the network. The network apparatus, with the assistance of other network functions in the network, derives the total energy consumption, and evaluates the energy conditions of each application in the application group. When the energy constraints of one or more of the applications in the application group are met, the QoS of each application in the group is updated. The details of how much the QoS is updated for each application in the application group is described in this embodiment.

The steps of the procedure 1200 include:
0. [Pre-requisite]: The UE device has the capability to report application group energy metrics to the network as defined earlier in the disclosure.
1. An application group energy tolerance configuration information is provided to the network apparatus e.g., an Application Function in the operator network. This configuration information could be provided, for example, using the M1 provisioning interface specified in TS 26501 and TS 26510. The application group energy tolerance information has the following information:

| Parameter | Description |
|---|---|
| Application energy | Collection of application energy tolerances of all individual applications as described earlier in |
| tolerance collection | the disclosure. |
| | The application energy tolerance for each individual application has the following details as |
| | described earlier in the disclosure: |
| | Application-tolerance-value |
| | Service-quality-level |
| | Energy-constraints |
| | Application-tolerance-value-map |
| | In addition to the above details, the following additional information may be included: |
| | Application-score: A numerical score assigned to the application, and used to infer the |
| | proportionality of application to the entire application group |
| | Application-rate-factor: Rate at which the QoS of the application is to be modified in case this |
| | application is not the one whose energy constraints are met, but just a member in the application |
| | group in which a different application was responsible for energy constraint violation. |
| Application Regular | Collection of regular QoS of all applications in the application group. The QoS for application is |
| QoS collection | specified in TS 26501 and TS 26510. |
| Application energy- | Collection of energy-constrained-QoS of all applications in the application group. |
| constrained-QoS | The energy constrained QoS is described in this disclosure |
| collection | |

When the above information is provisioned/configured at the Application Function, the Application Function attempts to request provisioning of regular QoS for each application in the application group as requested in ‘Application Regular QoS collection’ using existing procedures specified in TS 26501 and TS 26510.
   [At this stage, all applications are provisioned and the UE can start accessing those applications]
2. Different network functions in the operator network monitor data traffic of each application in the application group, and derive energy consumption information, and share it with Energy Function using existing procedures specified in TS 23501, TS 23502, and TS 23503.
3. UE, or the UE Energy Application, shares the UE energy report or the Application Group Energy report with the Application Function or the Energy Function. The Application group energy report includes the application energy report for each application in the application group. To share this information, the UE may use M5 interface specified in TS 26501 and TS 26510.
4. The Application Function and the Energy Function may check the application energy tolerance status for each application in the application group to identify if the application group needs QoS degradation. The method to determine if the application group needs QoS adjustment is described later in the embodiment. The QoS adjustment method may determine the adjustment of QoS for each individual application separately as a result of this procedure.
5. The Application Function may interact with other network functions (e.g., PCF, SMF, etc.) to enforce QoS adjustment for each application in the application group.

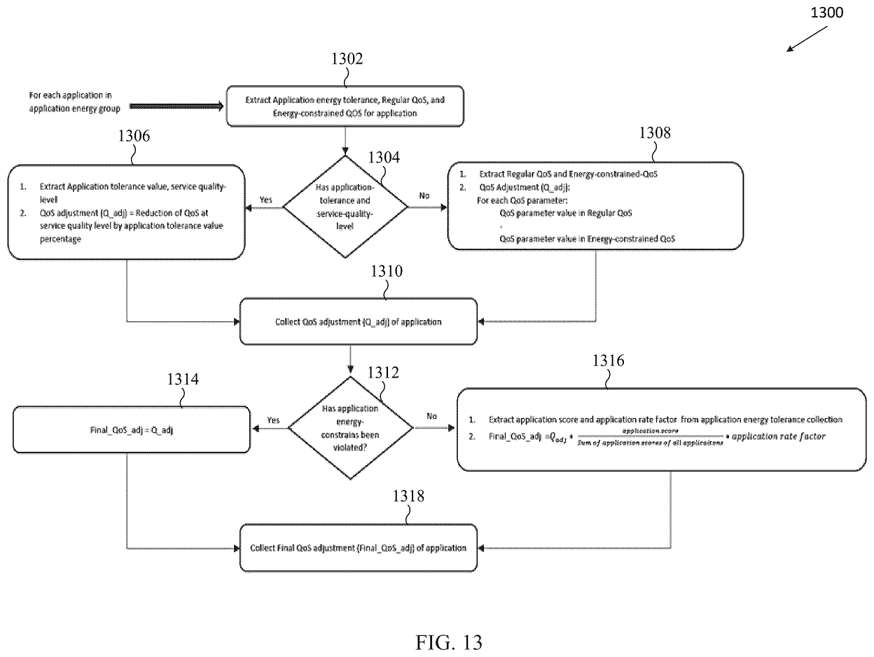

FIG. 13 illustrates an example method 1300 for determining how the QoS of each application is to be adjusted according to embodiments of the present disclosure. The example method for determining how the QoS of each application is to be adjusted is for illustration only. Different embodiments of an example method for determining how the QoS of each application is to be adjusted could be used without departing from the scope of this disclosure.

As shown at FIG. 13, the method steps are described below. For each application,
a) Extract application energy tolerance, regular QoS, energy-constrained QoS information for the application (1302)
b) Check if application tolerance and service-quality-level values are populated (1304). If yes, go to step c (1306). Otherwise, go to step d (1308)
c) Extract application tolerance value, service-quality-level from application tolerance information. Determine QoS adjustment (Q_adj)=Reduction of QoS at service quality level by application tolerance value percentage as described in this disclosure. Goto step e (1310)
d) Extract Regular QoS, Energy-constrained-QoS. Determine QoS adjust (Q_adj): For each QoS parameter: QoS param value=QoS Parameter value in Regular QoS-QoS Param value in Energy-constrained-QoS
e) Collect the QoS adjustment (Q_adj) for application
f) Check if application energy constraints are violated as described in this disclosure (based on energy metrics received from network functions and UE) (1312). If yes, go to step g (1314). Otherwise, go to step h (1316)
g) Final QoS adjustment (Final_QoS_adj)=Q_adj. Go to step I (1318)
h) Extract application score and application rate factor from application energy tolerance collection. Final QoS adjustment

$$( Final\_QoS \_adj ) = {Q}_{adj} * \frac{application score}{Sum of application scores of all applcations} * application rate factor$$

i) Collect the final QoS adjustment (Final_QoS_adj) for application

Repeat all above steps for each application in the application group, and the Application Function now possesses the QoS adjustment for each application.

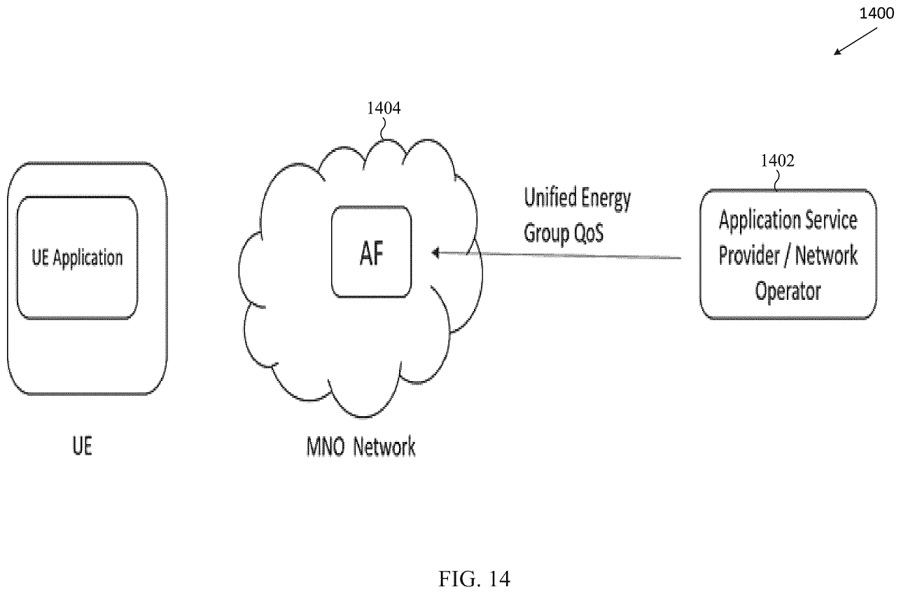

FIG. 14 illustrates an example configuration of unified energy group QoS 1400 according to embodiments of the present disclosure. The embodiment of an example configuration of unified energy group QoS of FIG. 14 is for illustration only. Different embodiments of an example configuration of unified energy group QoS could be used without departing from the scope of this disclosure.

As shown in FIG. 14, the Application Service Provider 1402 or the network operator 1404 may configure the Unified Energy Group QoS. The Application Service Provider 1402 may use the M1 Provisioning API, described in TS 26501 and TS 26510, to configure the Unified Energy Group QoS for an Application Energy Group at an Application Function. The Network Operator may use internal API to configure the Unified Energy Group QoS for an Application Energy Group at an Application Function.

The Unified Energy Group QoS may include the following information.

| Parameter | Description |
|---|---|
| Unified Group | Represents the QoS for the entire Application Group. The QoS parameters specified in this |
| QoS Specification | parameter include the following: |
| | All the QoS parameters described in this disclosure for individual application QoS |
| | All the QoS parameters described in TS 26501 and TS 26510 for application QoS |
| | All the QoE parameters described in TS 26247 for application QoE |
| | For example, if there are two applications in the group (App1 and App2), |
| | As per the earlier embodiments: the individual QoS specification (e.g., for an example QoS |
| | parameter packet latency) could have been defined as follows: |
| | Packet latency QoS for App1: 10 msec |
| | Packet latency QoS for App2: 8 msec |
| | As per this embodiment, the application service provider or network operator may provision one |
| | packet latency QoS parameter for entire group: |
| | Packet latency QoS for Application Energy Group: 8 msec |
| | I.e., the application service provider or network operator may configure Packet latency QoS |
| | parameters for entire group |
| | Similar to above, the application service provider may configure different QoS parameters for |
| | entire application energy group. |
| Aggregate QoS | Instead of configuring the detailed QoS specification for entire group, the application service |
| Parameter Function | provider and/or the network operator may just configure aggregate functions for each QoS |
| Map | parameter. The aggregate function may be evaluated against the corresponding parameter for each |
| | application in the application energy group. |
| | The Map may be in the form of <Key, Value> pair, where |
| | Key represents the QoS parameter |
| | Value represents the Aggregate Function |
| | For example, with the following entry in this map: |
| | Key = Packet Latency |
| | Value = Min |
| | The above indicates that the Application Function need to collect all the packet latency |
| | requirements of all applications in the application energy group, and then find the minimum value |
| | of all of them. This minimum value becomes the packet latency requirement of the entire |
| | application energy group. |
| | The Key value may be any of the QoS parameters described for individual application described in |
| | this disclosure or that have been specified in TS 26501, TS 26510, or TS 26247. |
| | The Aggregate Function in the Value field may be any of: |
| | Min: Take the value of all applications in the application energy group, for the parameter |
| | indicated by Key, extract the minimum among those values, and assign it to energy group for the |
| | same parameter |
| | Max: Take the value of all applications in the application energy group, for the parameter |
| | indicated by Key, extract the maximum among those values, and assign it to energy group for the |
| | same parameter |
| | Avg: Take the value of all applications in the application energy group, for the parameter |
| | indicated by Key, infer the average of those values, and assign it to energy group for the same |
| | parameter |
| | Med: Take the value of all applications in the application energy group, for the parameter |
| | indicated by Key, infer the median of those values, and assign it to energy group for the same |
| | parameter |
| | Sum: Take the value of all applications in the application energy group, for the parameter |
| | indicated by Key, infer the sum of those values, and assign it to energy group for the same |
| | parameter |
| | Any other mathematical aggregate functions may be specified in this field as well. |

Described earlier in the disclosure is a method for configuration of group tolerance for applications in the application energy group. In that embodiment, the tolerance for each application in the application group was configured separately and that represented the group tolerance for the application energy group. In this embodiment, an alternate method for configuration of group tolerance is described.

In this embodiment, the unified application energy group tolerance may be configured by the network operator and/or the application service provider using the M1 Provisioning API, described in TS 26501 and TS 26510. The Application Energy tolerance may include the following information:

| Parameters | Description |
|---|---|
| Unified-Group- | A tolerance value that signifies how much the |
| tolerance- | service quality may be degraded for the UE |
| adjustment- | application energy group. |
| value | This is a single scalar value for cases when the |
| | service quality degradation is performed on |
| | basis of a simple percentage drop off. |
| | For example, a value of 0.2 indicates that the |
| | service quality may be degraded, for one or |
| | more applications in the application energy |
| | group, up to a maximum of 20% from the peak |
| | maximum service quality value. |
| Unified-Group- | Level of service quality at which the above |
| service- | tolerance scalar value is to be checked for |
| quality-level | degrading. The service quality level can be any |
| | of the following: |
| | Application: The configured tolerance- |
| | value is at the level of the whole |
| | application among. This option indicates |
| | that the application quality is to be |
| | checked and allowed to be degraded, for |
| | one or more applications in the |
| | application energy group, up to the |
| | configured adjustment-value, because of |
| | energy constraints. |
| | PDU-Session: The configured tolerance- |
| | value is at the level of PDU session. This |
| | option indicates that the PDU session |
| | quality is to be checked and allowed to |
| | be degraded, for one or more |
| | applications in the application energy |
| | group, up to the configured adjustment - |
| | value, because of energy constraints. |
| | flow: The configured tolerance-value is |
| | at the level of service flows. This option |
| | indicates that the PDU session quality is |
| | to be checked and allowed to be |
| | degraded, for one or more applications in |
| | the application energy group, up to the |
| | configured adjustment -value, because of |
| | energy constraints |
| | Slice: The configured tolerance-value is |
| | at the level of network slices. This option |
| | indicates that the slice quality is to be |
| | checked and allowed to be degraded, for |
| | one or more applications in the |
| | application energy group, up to the |
| | configured adjustment-value, because of |
| | energy constraints |
| Unified-Group- | List of objects describing all the energy |
| energy- | constraints. Each member object of this list may |
| constraints | include the following information: |
| | energy-constraint-id: Identifier assigned |
| | to this energy constraint object. The |
| | energy-constraint-id is used to correlate |
| | energy conditions to tolerance values |
| | (described next) |
| | parameter-low-threshold: Lower value of |
| | the energy range |
| | parameter-high-threshold: Higher value |
| | of the energy range |
| | parameter-name: parameter for which the |
| | range is considered |
| | The parameters could be any of the following: |
| | Batter level |
| | Energy Source |
| | Energy Capacity |
| | Energy Level |
| | Average Source Temperature |
| | Average CO2e emission |
| | Energy drain average |
| | Energy measurement time span |
| | Energy Consumption Rate |
| | Carbon Intensity |
| | Discharge rate |
| Unified-Group- | Map of tolerance adjustment values for different |
| tolerance- | ranges of energy constraints. Each element of |
| adjustment- | the map is of the form <key, value> pair where |
| value-map | in: |
| | key represents the energy constraint |
| | identifier describing the energy |
| | condition |
| | value represents the tolerance value if |
| | the energy condition represented by the |
| | energy constraint identifier is satisfied. |
| | The tolerance value has the following |
| | information |
| | range- adjustment -value: Scalar |
| | tolerance value for the given |
| | energy range |
| | range-service-quality-level: The |
| | levels at which the above range- |
| | adjustment -value is applicable |
| | for. The different types of service |
| | quality levels here is same as |
| | defined earlier in the |
| | embodiment. |
| | By specifying range-service-quality values and |
| | range- adjustment values for different energy |
| | conditions, it becomes possible that application |
| | energy group service quality to be modified |
| | differently at different energy constraints. |
| | For example, with the following key and value: |
| | key pointing to an energy condition with |
| | following information: |
| | parameter-low-threshold: 0.2 |
| | parameter-high-threshold: 0.4 |
| | parameter-name: battery-level |
| | value: |
| | range- adjustment -value: 0.2 |
| | range-service-quality-level: PDU-Session |
| | For the above example values, the battery level |
| | of the UE can be checked to see if the energy |
| | availability is in between 20%-40% range, then |
| | the service quality, for one or more applications |
| | in the application energy group, can be lowered |
| | by 20% at the PDU Session level. |
| | More values could be defined in this map. |
| | Another key, value pair in this map for example |
| | could be: |
| | key pointing to an energy condition |
| | with following information: |
| | parameter-low-threshold: 0.1 |
| | parameter-high-threshold: 0.2 |
| | parameter-name: battery-level |
| | value: |
| | range- adjustment -value: 0.6 |
| | range-service-quality-level: PDU-Session |
| | The above values signify that if the battery level |
| | of the UE i.e., the energy availability is in |
| | between 10%-20% range, then the service |
| | quality, for one or more applications in the |
| | application energy group, can be lowered by |
| | 60% at the PDU Session level instead of just the |
| | 20% with the previous key value example pair. |

Which applications in the application energy group to consider for degradation based on above table is as per the method described earlier in the disclosure for QoS degradation for applications in the application energy group.

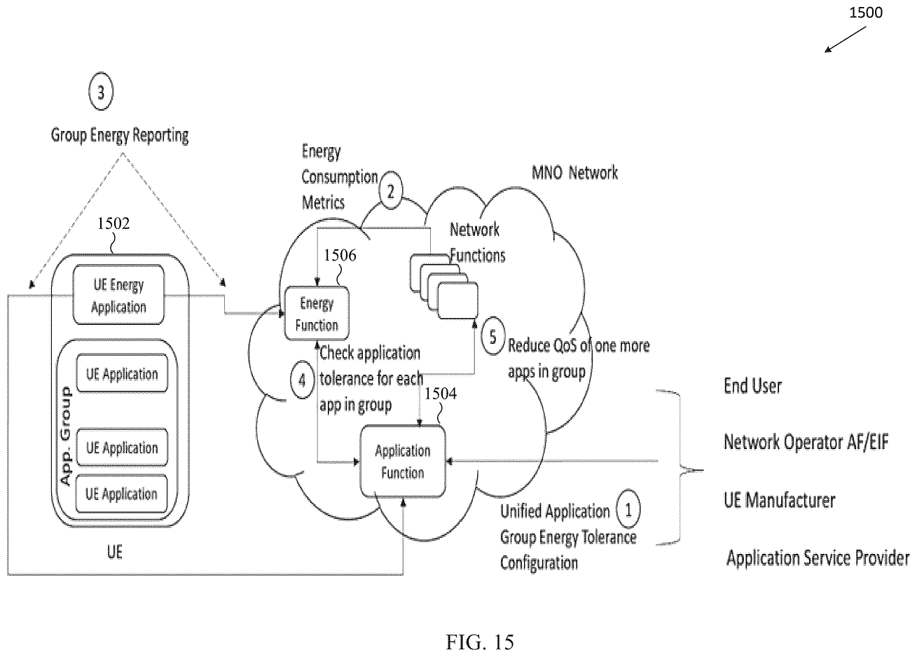

FIG. 15 illustrates an example procedure 1500 for QoS degradation of applications in an application group based on unified group QoS tolerance according to embodiments of the present disclosure. The embodiment of an example procedure for QoS degradation of applications in an application group based on unified group QoS tolerance of FIG. 15 is for illustration only. Different embodiments of an example procedure for QoS degradation of applications in an application group based on unified group QoS tolerance could be used without departing from the scope of this disclosure.

As shown in FIG. 15, the steps of the procedure 1500 include:
0. [Pre-requisite]: The UE device 1502 has the capability to report application group energy metrics to the network as defined earlier in the disclosure.
1. A unified application group energy tolerance configuration information is provided to the network apparatus e.g., an Application Function 1504 in the operator network. This configuration information could be provided, for example, using the M1 provisioning interface specified in TS 26501 and TS 26510. The unified application group energy tolerance configuration information has the following information:

| Parameter | Description |
|---|---|
| Unified Application | As described earlier in the disclosure |
| energy group tolerance | |
| Unified Energy Group | As described earlier in the disclosure |
| Qos | |
| Application energy | As described earlier in the disclosure |
| tolerance collection | |
| Application Regular | As described earlier in the disclosure |
| QoS collection | |

When the above information is provisioned/configured at the Application Function 1504, the Application Function attempts to request provisioning of regular QoS for each application in the application group as requested in ‘Application Regular QoS collection’ using procedures described earlier in this disclosure.
   [At this stage, all applications are provisioned and the UE can start accessing those applications]
2. Different network functions in the operator network monitor data traffic of each application in the application group, and derive energy consumption information, and share it with Energy Function 1506 using existing procedures specified in TS 23501, TS 23502, and TS 23503.
3. The UE, or the UE Energy Application, shares the UE energy report or the Application Group Energy report with the Application Function or the Energy Function. The Application group energy report includes the application energy report for each application in the application group. To share this information, the UE may use M5 interface specified in TS 26501 and TS 26510.
4. The Application Function 1504 and the Energy Function 1506, may check the unified application energy group tolerance by inferring the group QoS parameter values, and evaluate them against the configured unified application energy group tolerance and/or unified energy QoS. When the inferred values fall short of configured unified application energy group QoS values, QoS of one or more applications may be degraded using the procedure for QoS degradation of applications described earlier. That procedure may indicate the needed QoS adjustments for one or more individual applications separately.
5. The Application Function 1504 may interact with other network functions (e.g., PCF, SMF, etc.) to enforce QoS adjustment for each application in the application group.

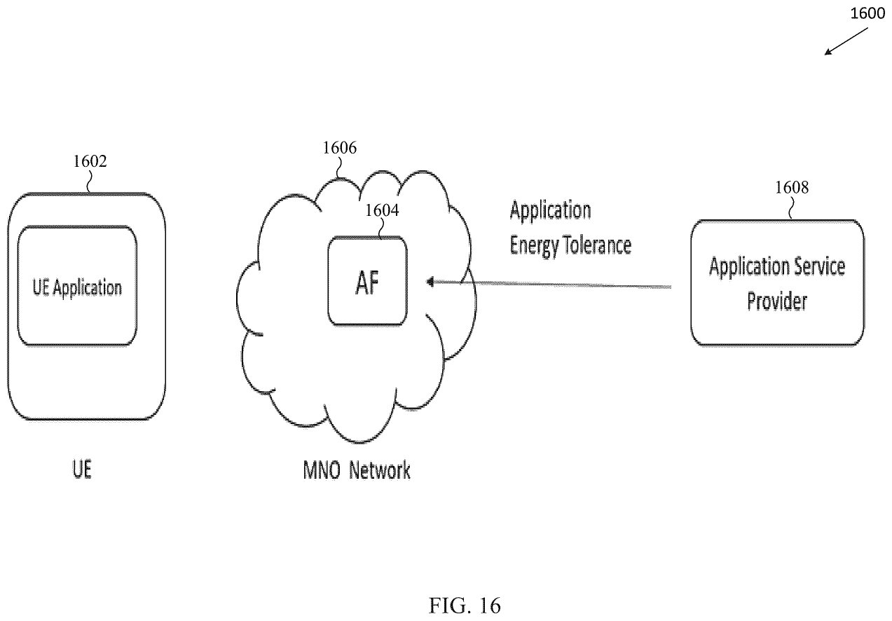

FIG. 16 illustrates an example procedure 1600 for QoS degradation of applications given reduced QoS configuration for application energy tolerance according to embodiments of the present disclosure. The embodiment of an example procedure for QoS degradation of applications given reduced QoS configuration for application energy tolerance of FIG. 16 is for illustration only. Different embodiments of an example procedure for QoS degradation of applications given reduced QoS configuration for application energy tolerance could be used without departing from the scope of this disclosure.

As shown in FIG. 16, the network operator and/or the application service provider 1608, may use existing interfaces to configure application energy tolerance for an application on the UE 1602 at the Application Function 1604 in MNO network 1606. For example, the application service provider 1608 may use the M1 interface specified in TS 26501 and TS 26510 to configure the application energy tolerance for an application on the UE at the Application Function 1604 in the operator network. The network operator may then use M5 interface specified in TS 26501 and TS 26510 to configure the application energy tolerance for an application on the UE. The application service provider may also use the M8 interface defined in TS 26501 and TS 26510 to configure the application energy tolerance for an application on the UE.

The following information may be included in the service configuration information that gets configured for an application service.

| Parameter | Description |
|---|---|
| Regular QoS | QoS requirements for the application service given no |
| requirements | restrictions with energy, either in the UE or in the |
| | network. These requirements are as specified in TS |
| | 26501 and TS 26510 |
| Energy | Provides energy constraint information as described in |
| constraints | the earlier embodiment. |
| Energy- | A reduced QoS requirement set for the application |
| constrained- | service when the UE application QoS is downgraded |
| QoS | because of observation of energy conditions. The format |
| | and the individual QoS parameters in this energy- |
| | constrained-QoS are the same parameters as that of |
| | Regular QoS requirements. |
| | Because this is QoS requirements for energy-constrained |
| | scenarios, the QoS requirements in this set are less |
| | demanding than that of the Regular QoS requirements |

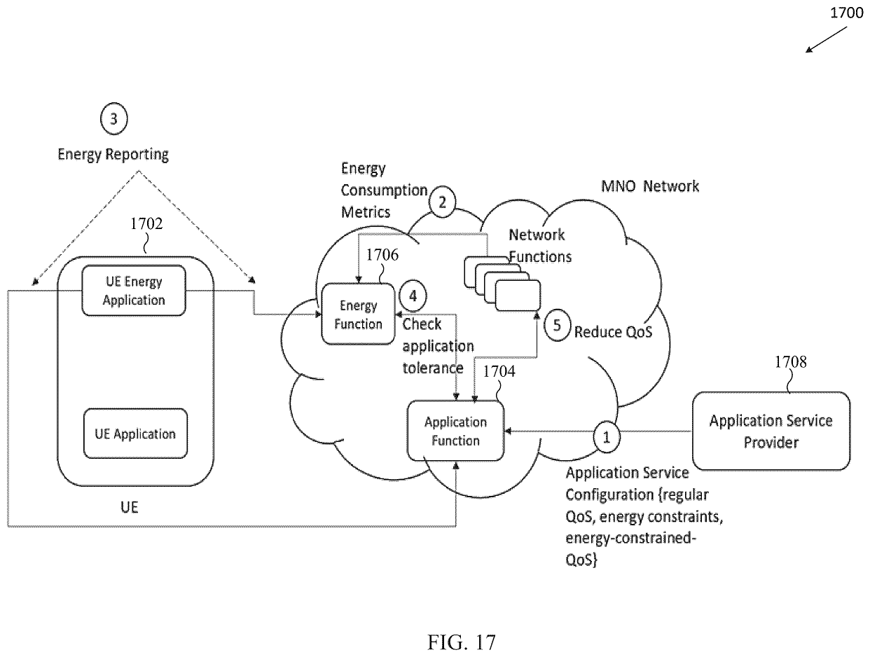

FIG. 17 illustrates an example procedure 1700 for QoS degradation of applications given QoS configurations for regular and energy constrained scenarios according to embodiments of the present disclosure. The embodiment of an example procedure for QoS degradation of applications given QoS configurations for regular and energy constrained scenarios of FIG. 17 is for illustration only. Different embodiments of an example procedure for QoS degradation of applications given QoS configurations for regular and energy constrained scenarios could be used without departing from the scope of this disclosure.

As shown in FIG. 17, the steps of the procedure include:
0. An application served by an Application Service Provider 1708 is installed on the UE's device. The UE device has the capability to report energy metrics to the network as defined earlier in the disclosure.
1. The Application Service Provider 1708 configures an application service at the Application Function 1704 in the operator network. The application service provider could use the M1 provisioning interface specified in TS 26501 and TS 26510 to configure the application service in the operator network. The service configuration from the application service provider includes the following details, in addition to the service configuration information specified in TS 26501 and TS 26510.

| Parameter | Description |
|---|---|
| Regular QoS | QoS requirements as defined currently in TS 26501 |
| | and TS 26510. |
| Energy- | List of energy conditions as described in the earlier |
| constraints | embodiment |
| Energy- | QoS requirements as described in this embodiment |
| constrained- | |
| QoS | |

When the above information is provisioned by the application service provider, the Application Function 1704 attempts to request provisioning of QoS as requested in ‘regular QoS’ using existing procedures specified in TS 26501 and TS 26510.
2. Different network functions in the operator network monitor data traffic of the application and derive energy consumption information, and share it with Energy Function 1706 using existing procedures specified in TS 23501, TS 23502, and TS 23503.
3. The UE 1702, or the UE Energy Application, shares the UE energy report or the Application Energy report with the Application Function 1704 or the Energy Function 1706. To share this information, the UE may use M5 interface specified in TS 26501 and TS 26510.
4. The Application Function 1704 and the Energy Function 1706 may check the application energy tolerance status to identify the need for QoS degradation. The following steps are performed in this check:
   a. Check the configured regular QoS requirements of the application
   b. Extract each energy condition from service configuration information and evaluate against the metrics data received from network functions and UE
   c. If any energy condition is satisfied i.e., if the derived energy consumption metrics show that certain energy condition is true, then mark that the application QoS is to be lowered because of energy constraints.
5. If it is marked in step-4 above that the application QoS is to be lowered, then the Application Function interacts with other network functions (e.g., PCF, SMF etc.) to provision the energy-constrained-QoS for the application.

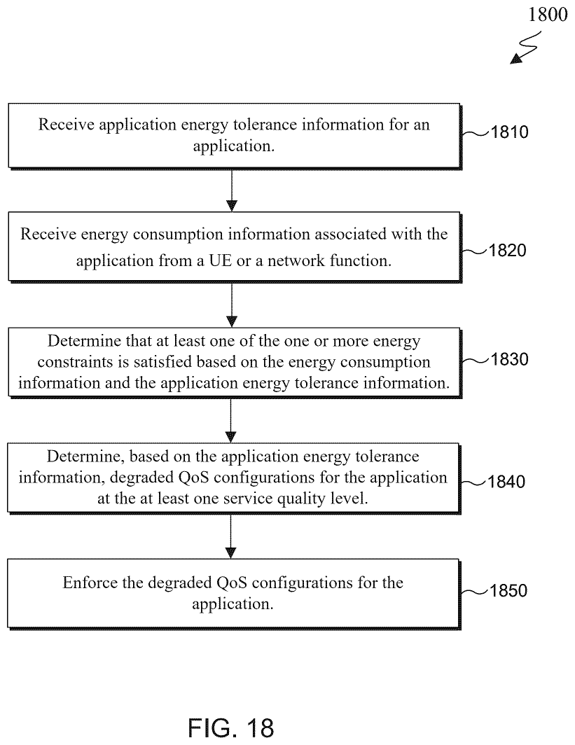

FIG. 18 illustrates an example method 1800 for energy policy reinforcement during energy conservation tasks according to embodiments of the present disclosure. For example, the method 1800 may be implemented by an electronic device, such as one or more of electronic devices 200 and 300 in FIGS. 2 and 3, respectively. An embodiment of the method illustrated in FIG. 18 is for illustration only. Other embodiments of the method 1800 for energy policy reinforcement during energy conservation tasks could be used without departing from the scope of this disclosure.

The method begins with the electronic device receiving application energy tolerance information for an application (1810). The electronic device then receives energy consumption information associated with the application from a UE or a network function (1820). For example, in 1820, the application energy tolerance information includes at least one tolerance value indicating an amount of service quality degradation permitted for the application under one or more energy constraints and at least one service quality level at which the tolerance value is to be applied.

The electronic device then determines that at least one of the one or more energy constraints is satisfied based on the energy consumption information and the application energy tolerance information (1830). The electronic device then determines, based on the application energy tolerance information, degraded QoS configurations for the application at the at least one service quality level (1840). The electronic device then enforces the degraded QoS configurations for the application (1850).

In various embodiments, for each of a plurality of service quality levels including at least one of an application level, a PDU session level, a service flow level, and a network slice level, the electronic device identifies a corresponding tolerance value from the application energy tolerance information and reduces, for each service quality level, a QoS parameter for the application by an amount proportional to the corresponding tolerance value to obtain the degraded QoS configurations at the each service quality level.

In various embodiments, the electronic device receives application group energy tolerance information for an application group including a plurality of applications, the application group energy tolerance information including, for each application of the plurality of applications, application energy tolerance information and at least one of an application score and an application rate factor. The electronic device receives application group energy reporting information including an energy report for each application in the application group and determine, based on the application group energy tolerance information and the application group energy reporting information, respective QoS adjustments for the plurality of applications in the application group.

In various embodiments, the electronic device identifies, for each application in the application group, whether energy constraints for that application are violated based on the energy report for the application and corresponding application energy tolerance information, determines, for an application whose energy constraints are violated, a first QoS adjustment based on at least one of an application tolerance value and an energy-constrained QoS configuration defined for the application, determines, for one or more other applications in the application group whose energy constraints are not violated, a second QoS adjustment based on at least one of an application score and an application rate factor for the other applications and a sum of application scores of all applications in the application group; and enforces QoS configurations for the applications in the application group based on the first QoS adjustment and the second QoS adjustment.

In various embodiments, the electronic device receives unified energy group QoS information for the application group. The unified energy group QoS information includes a unified group QoS specification representing QoS parameters for the application group and an aggregate QoS parameter function map defining, for each QoS parameter of the unified group QoS specification, an aggregate function to be applied across QoS values of the plurality of applications. The electronic device receives unified application energy group tolerance information including a unified application energy group tolerance value for the application group and an application regular QoS collection for the plurality of applications, infers, based on the aggregate QoS parameter function map and the application regular QoS collection, a group QoS parameter value for at least one QoS parameter of the unified group QoS specification, determines that the inferred group QoS parameter value falls short of a configured unified group QoS parameter value, and determines respective QoS adjustments for one or more applications in the application group according to the unified application energy group tolerance information.

In various embodiments, the electronic device receives unified application energy group tolerance information for the application group. The unified application energy group tolerance information includes a unified group service quality level indicating a service quality level for the application group and unified group energy constraints indicating energy constraints for the application group. The electronic device determines whether to degrade the service quality level for the application group based on the energy constraints for the application group and determines QoS adjustments for the application group according to the determination.

In various embodiments, the electronic device transmits, information indicative of the degraded QoS configurations and associated application identifiers, group identifiers, and QoS parameter changes, receives, a set of energy policy enforcement actions specifying, for at least one of a UE level, an application level, an application flow level, a protocol data unit (PDU) session level, an application group level, and a network slice or data network level, an enforcement method including stop, start, restart, terminate, and none, and coordinates, based on the received energy policy enforcement actions, with at least one of a policy control function, a session management function, an access and mobility function, and an application server to implement the enforcement method in conjunction with the degraded QoS configurations.

In various embodiments, the energy policy enforcement actions including at least one of an expiry interval indicating a duration for which a current set of energy enforcement actions, including the degraded QoS configurations, is applicable and a plurality of time periods, each associated with a different set of energy enforcement actions to be applied to an application energy group. The electronic device applies the degraded QoS configurations and corresponding energy enforcement actions during the expiry interval or during each respective time period and ceases application of the energy enforcement actions for the application energy group when the expiry interval or each respective time period expires and no updated enforcement actions are received.

In various embodiments, the application energy tolerance information is based on a reduced QoS configuration for the application that is configured at a network operator.

In various embodiments, the application energy tolerance information received further includes a reduced QoS configuration for the application. The electronic device determines to use an energy constrained QoS based on the reduced QoS configuration and the energy consumption information and determines the degraded QoS configurations based on the reduced QoS configuration and the determination to use the energy constrained QoS.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for managing service quality of one or more applications, the method comprising:
receiving application energy tolerance information for an application, wherein the application energy tolerance information includes (i) at least one tolerance value indicating an amount of service quality degradation permitted for the application under one or more energy constraints and (ii) at least one service quality level at which the tolerance value is to be applied;
receiving energy consumption information associated with the application from a user equipment (UE) or a network function;
determining that at least one of the one or more energy constraints is satisfied based on the energy consumption information and the application energy tolerance information;
determining, based on the application energy tolerance information, degraded quality of service (QoS) configurations for the application at the at least one service quality level; and
enforcing the degraded QoS configurations for the application.

2. The method of claim 1, wherein determining the degraded QoS configurations comprises, for each of a plurality of service quality levels including at least one of an application level, a protocol data unit (PDU) session level, a service flow level, and a network slice level:
identifying a corresponding tolerance value from the application energy tolerance information; and
reducing, for each service quality level, a QoS parameter for the application by an amount proportional to the corresponding tolerance value to obtain the degraded QoS configurations at the each service quality level.

3. The method of claim 1, further comprising:
receiving application group energy tolerance information for an application group including a plurality of applications, the application group energy tolerance information including, for each application of the plurality of applications, (i) application energy tolerance information and (ii) at least one of an application score and an application rate factor;
receiving application group energy reporting information including an energy report for each application in the application group; and
determining, based on the application group energy tolerance information and the application group energy reporting information, respective QoS adjustments for the plurality of applications in the application group.

4. The method of claim 3, wherein:
determining the respective QoS adjustments for the plurality of applications in the application group comprises:
identifying, for each application in the application group, whether energy constraints for that application are violated based on the energy report for the application and corresponding application energy tolerance information;
determining, for an application whose energy constraints are violated, a first QoS adjustment based on at least one of an application tolerance value and an energy-constrained QoS configuration defined for the application; and
determining, for one or more other applications in the application group whose energy constraints are not violated, a second QoS adjustment based on (i) at least one of an application score and an application rate factor for the other applications and (ii) a sum of application scores of all applications in the application group; and
the method further comprises enforcing QoS configurations for the applications in the application group based on the first QoS adjustment and the second QoS adjustment.

5. The method of claim 3, further comprising:
receiving unified energy group QoS information for the application group, wherein the unified energy group QoS information includes (i) a unified group QoS specification representing QoS parameters for the application group and (ii) an aggregate QoS parameter function map defining, for each QoS parameter of the unified group QoS specification, an aggregate function to be applied across QoS values of the plurality of applications;
receiving unified application energy group tolerance information including a unified application energy group tolerance value for the application group and an application regular QoS collection for the plurality of applications;
inferring, based on the aggregate QoS parameter function map and the application regular QoS collection, a group QoS parameter value for at least one QoS parameter of the unified group QoS specification;
determining that the inferred group QoS parameter value falls short of a configured unified group QoS parameter value; and
determining respective QoS adjustments for one or more applications in the application group according to the unified application energy group tolerance information.

6. The method of claim 3, further comprising:
receiving unified application energy group tolerance information for the application group, wherein the unified application energy group tolerance information includes (i) a unified group service quality level indicating a service quality level for the application group and (ii) unified group energy constraints indicating energy constraints for the application group;
determining whether to degrade the service quality level for the application group based on the energy constraints for the application group; and
determining QoS adjustments for the application group according to the determination.

7. The method of claim 1, further comprising:
transmitting, information indicative of the degraded QoS configurations and associated application identifiers, group identifiers, and QoS parameter changes;
receiving, a set of energy policy enforcement actions specifying, for at least one of a UE level, an application level, an application flow level, a protocol data unit (PDU) session level, an application group level, and a network slice or data network level, an enforcement method including stop, start, restart, terminate, and none; and
coordinating, based on the received energy policy enforcement actions, with at least one of a policy control function, a session management function, an access and mobility function, and an application server to implement the enforcement method in conjunction with the degraded QoS configurations.

8. The method of claim 7, wherein:
the energy policy enforcement actions including at least one of (i) an expiry interval indicating a duration for which a current set of energy enforcement actions, including the degraded QoS configurations, is applicable and (ii) a plurality of time periods, each associated with a different set of energy enforcement actions to be applied to an application energy group; and
the method further comprises:
applying the degraded QoS configurations and corresponding energy enforcement actions during the expiry interval or during each respective time period; and
ceasing application of the energy enforcement actions for the application energy group when the expiry interval or each respective time period expires and no updated enforcement actions are received.

9. The method of claim 1, wherein the application energy tolerance information is based on a reduced QoS configuration for the application that is configured at a network operator.

10. The method of claim 1, wherein:
the application energy tolerance information received further includes a reduced QoS configuration for the application;
the method further comprises determining to use an energy constrained QoS based on the reduced QoS configuration and the energy consumption information; and
wherein determining the degraded QoS configurations comprises determining the degraded QoS configurations based on the reduced QoS configuration and the determination to use the energy constrained QoS.

11. An electronic device for managing service quality of one or more applications, the electronic device comprising:
memory storing program code; and
a processor operably coupled to the memory, the processor configured to execute the program code to cause the electronic device to:
receive application energy tolerance information for an application, wherein the application energy tolerance information includes (i) at least one tolerance value indicating an amount of service quality degradation permitted for the application under one or more energy constraints and (ii) at least one service quality level at which the tolerance value is to be applied;
receive energy consumption information associated with the application from a user equipment (UE) or a network function;
determine that at least one of the one or more energy constraints is satisfied based on the energy consumption information and the application energy tolerance information;
determine, based on the application energy tolerance information, degraded quality of service (QoS) configurations for the application at the at least one service quality level; and
enforce the degraded QoS configurations for the application.

12. The electronic device of claim 11, wherein the processor is further configured to execute the program code to cause the electronic device to, for each of a plurality of service quality levels including at least one of an application level, a protocol data unit (PDU) session level, a service flow level, and a network slice level:
identify a corresponding tolerance value from the application energy tolerance information; and
reduce, for each service quality level, a QoS parameter for the application by an amount proportional to the corresponding tolerance value to obtain the degraded QoS configurations at the each service quality level.

13. The electronic device of claim 11, wherein the processor is further configured to execute the program code to cause the electronic device to:
receive application group energy tolerance information for an application group including a plurality of applications, the application group energy tolerance information including, for each application of the plurality of applications, (i) application energy tolerance information and (ii) at least one of an application score and an application rate factor;
receive application group energy reporting information including an energy report for each application in the application group; and
determine, based on the application group energy tolerance information and the application group energy reporting information, respective QoS adjustments for the plurality of applications in the application group.

14. The electronic device of claim 13, wherein the processor is further configured to execute the program code to cause the electronic device to:
identify, for each application in the application group, whether energy constraints for that application are violated based on the energy report for the application and corresponding application energy tolerance information;
determine, for an application whose energy constraints are violated, a first QoS adjustment based on at least one of an application tolerance value and an energy-constrained QoS configuration defined for the application;
determine, for one or more other applications in the application group whose energy constraints are not violated, a second QoS adjustment based on (i) at least one of an application score and an application rate factor for the other applications and (ii) a sum of application scores of all applications in the application group; and
enforce QoS configurations for the applications in the application group based on the first QoS adjustment and the second QoS adjustment.

15. The electronic device of claim 13, wherein the processor is further configured to execute the program code to cause the electronic device to:
receive unified energy group QoS information for the application group, wherein the unified energy group QoS information includes (i) a unified group QoS specification representing QoS parameters for the application group and (ii) an aggregate QoS parameter function map defining, for each QoS parameter of the unified group QoS specification, an aggregate function to be applied across QoS values of the plurality of applications;
receive unified application energy group tolerance information including a unified application energy group tolerance value for the application group and an application regular QoS collection for the plurality of applications;
infer, based on the aggregate QoS parameter function map and the application regular QoS collection, a group QoS parameter value for at least one QoS parameter of the unified group QoS specification;
determine that the inferred group QoS parameter value falls short of a configured unified group QoS parameter value; and
determine respective QoS adjustments for one or more applications in the application group according to the unified application energy group tolerance information.

16. The electronic device of claim 13, wherein the processor is further configured to execute the program code to cause the electronic device to:
receive unified application energy group tolerance information for the application group, wherein the unified application energy group tolerance information includes (i) a unified group service quality level indicating a service quality level for the application group and (ii) unified group energy constraints indicating energy constraints for the application group;
determine whether to degrade the service quality level for the application group based on the energy constraints for the application group; and
determine QoS adjustments for the application group according to the determination.

17. The electronic device of claim 11, wherein the processor is further configured to execute the program code to cause the electronic device to:
transmit, information indicative of the degraded QoS configurations and associated application identifiers, group identifiers, and QoS parameter changes;
receive, a set of energy policy enforcement actions specifying, for at least one of a UE level, an application level, an application flow level, a protocol data unit (PDU) session level, an application group level, and a network slice or data network level, an enforcement method including stop, start, restart, terminate, and none; and
coordinate, based on the received energy policy enforcement actions, with at least one of a policy control function, a session management function, an access and mobility function, and an application server to implement the enforcement method in conjunction with the degraded QoS configurations.

18. The electronic device of claim 17, wherein:
the energy policy enforcement actions including at least one of (i) an expiry interval indicating a duration for which a current set of energy enforcement actions, including the degraded QoS configurations, is applicable and (ii) a plurality of time periods, each associated with a different set of energy enforcement actions to be applied to an application energy group; and
the processor is further configured to execute the program code to cause the electronic device to:
apply the degraded QoS configurations and corresponding energy enforcement actions during the expiry interval or during each respective time period; and
cease application of the energy enforcement actions for the application energy group when the expiry interval or each respective time period expires and no updated enforcement actions are received.

19. The electronic device of claim 11, wherein the application energy tolerance information is based on a reduced QoS configuration for the application that is configured at a network operator.

20. The electronic device of claim 11, wherein:
the application energy tolerance information received further includes a reduced QoS configuration for the application; and
the processor is further configured to execute the program code to cause the electronic device to:
determine to use an energy constrained QoS based on the reduced QoS configuration and the energy consumption information; and
determine the degraded QoS configurations based on the reduced QoS configuration and the determination to use the energy constrained QoS.
